(19) United States
(12) Patent Application Publication
(10) Pub. No.: US 2022/0342186 A1
(43) Pub. Date: Oct. 27, 2022

(54) Optical Imaging Lens Group

(71) Applicant: ZHEJIANG SUNNY OPTICS CO.,LTD., Ningbo (CN)

(72) Inventors: Jianke WENREN, Ningbo (CN); Liefeng ZHAO, Ningbo (CN); Fujian DAI, Ningbo (CN)

(21) Appl. No.: 17/723,509

(22) Filed: Apr. 19, 2022

(30) Foreign Application Priority Data
Apr. 20, 2021 (CN) 202110433700.X

(51) Int. Cl. G02B 13/00; G02B 9/64

(52) U.S. Cl. CPC G02B 13/0045; G02B 9/64

(57) ABSTRACT

The disclosure provides an optical imaging lens group. The optical imaging lens group includes: a first lens, a second lens, a third lens, a fourth lens, a fifth lens, a sixth lens, a seventh lens and an iris diaphragm, the iris diaphragm is arranged between the first lens and the second lens. Wherein Fno2 is an F-number when an object distance of the optical imaging lens group is 1000 mm, Fno1 is an F-number when the object distance of the optical imaging lens group is 7000 mm, and Fno2 and Fno1 satisfy: 1.3<Fno2/Fno1<1.8; ImgH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5.

### CROSS-REFERENCE TO RELATED PRESENT INVENTIONS

The disclosure claims priority to and the benefit of Chinese Patent Present invention No.202110433700.X, filed in the China National Intellectual Property Administration (CNIPA) on 20 Apr. 2021, which is incorporated herein by reference in its entirety.

### TECHNICAL FIELD

The disclosure relates to the technical field of the optical imaging devices, and in particular, to an optical imaging lens group.

### BACKGROUND

In recent years, with the gradual popularization of smart terminals, people have higher and higher requirements for taking pictures with mobile phones. Rear cameras of major flagship phones are usually composed of an ultra-clear main camera, an extra-large wide-angle lens and a telephoto lens, which are switched in different modes to realize an ultra-clear photographing function. A plurality of camera lenses are arranged on the mobile phone to cooperate with an algorithm, so as to achieve high-definition photography. However, the increase in the number of camera modules takes up more volume of the terminal, which is not conducive to the trends of miniaturization and thinning of mobile phones.

That is to say, there is a problem in the related art that it is not easy to realize a minimization of a camera lens.

### SUMMARY

The main purpose of the disclosure is to provide an optical imaging lens group, so as to solve the problem in the related art that it is not easy to realize a minimization of a camera lens.

In order to achieve the above purpose, an embodiment of the disclosure provides an optical imaging lens group, which sequentially includes from an object side to an image side along an optical axis: a first lens with a positive refractive power, and an image-side surface of the first lens is a concave surface; a second lens with a refractive power, and an image-side surface of the second lens is a concave surface; a third lens with a refractive power; a fourth lens; a fifth lens with a refractive power, and an object-side surface of the fifth lens is a concave surface; a sixth lens with a positive refractive power, and an object-side surface of the sixth lens is a convex surface; a seventh lens with a negative refractive power, and an image-side surface of the seventh lens is a concave surface; and an iris diaphragm, the iris diaphragm is arranged between the first lens and the second lens, wherein Fno2 is an F-number when an object distance of the optical imaging lens group is 1000 mm, Fno1 is an F-number when the object distance of the optical imaging lens group is 7000 mm, and Fno2 and Fno1 satisfy: 1.3<Fno2/Fno1<1.8; ImgH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5.

In an implementation mode, an effective focal length f1 of the first lens and an effective focal length f6 of the sixth lens satisfy: 1<f1/f6<1.5.

In an implementation mode, T45 is an on-axis spacing distance between the fourth lens and the fifth lens, and T56 is an on-axis spacing distance between the fifth lens and the sixth lens, and T45 and T56 satisfy: 3<T45/T56<3.5.

In an implementation mode, a curvature radius R14 of the image-side surface of the seventh lens and an effective focal length f of the optical imaging lens group satisfy: R14/f<0.5.

In an implementation mode, a curvature radius R11 of the object-side surface of the sixth lens, and a curvature radius R14 of the image-side surface of the seventh lens satisfy: 0.9<R11/R14<1.3.

In an implementation mode, T45 is an on-axis spacing distance between the fourth lens and the fifth lens, a center thickness CT3 of the third lens on the optical axis, a center thickness CT4 of the fourth lens on the optical axis and T45 satisfy: 1<(CT3+CT4)/T45<1.5.

In an implementation mode, T56 is an on-axis spacing distance between the fifth lens and the sixth lens, T56 and a center thickness CT6 of the sixth lens on the optical axis satisfy: 0.2<T56/CT6<0.7.

In an implementation mode, a maximum effective radius DT21 of an object-side surface of the second lens and a maximum effective radius DT32 of an image-side surface of the third lens satisfy: 1<DT21/DT32<1.5.

In an implementation mode, a maximum effective radius DT72 of the image-side surface of the seventh lens and ImgH satisfy: 0.5<DT72/ImgH<1.

In an implementation mode, a maximum effective radius DT61 of the object-side surface of the sixth lens and a maximum effective radius DT52 of an image-side surface of the fifth lens satisfy: 0.2<(DT61−DT52)/DT52<0.6.

In an implementation mode, SAG51 is an on-axis spacing distance from an intersection point of the object-side surface of the fifth lens and the optical axis to an effective radius vertex of the object-side surface of the fifth lens, SAG51 and a center thickness CT5 of the fifth lens on the optical axis satisfy: −1.5<SAG51/CT5<−1.

In an implementation mode, SAG52 is an on-axis spacing distance from an intersection point of an image-side surface of the fifth lens and the optical axis to an effective radius vertex of the image-side surface of the fifth lens, SAG52 and a center thickness CT5 of the fifth lens on the optical axis satisfy: −1.8<SAG52/CT5<−1.3.

In an implementation mode, SAG61 is an on-axis spacing distance from an intersection point of the object-side surface of the sixth lens and the optical axis to an effective radius vertex of the object-side surface of the sixth lens, T56 is an on-axis spacing distance between the fifth lens and the sixth lens, and SAG61 and T56 satisfy: −1.5<SAG61/T56<−1.

In an implementation mode, SAG72 is an on-axis spacing distance from an intersection point of the image-side surface of the seventh lens and the optical axis to an effective radius vertex of the image-side surface of the seventh lens, SAG72 and a center thickness CT7 of the seventh lens on the optical axis satisfy: −2<SAG72/CT7<−1.

In an implementation mode, YC72 is a vertical distance from a critical point of the image-side surface of the seventh lens to the optical axis, YC72 and a maximum effective radius DT72 of the image-side surface of the seventh lens satisfy: 0.1<YC72/DT72<0.5.

In an implementation mode, an edge thickness ET3 of the third lens at a maximum effective diameter and a center thickness CT3 of the third lens on the optical axis satisfy: 0.5<ET3/CT3<1.

In an implementation mode, an edge thickness ET4 of the fourth lens at the maximum effective diameter and a center thickness CT4 of the fourth lens on the optical axis satisfy: 0.9<ET4/CT4<1.3.

In an implementation mode, YT62 is an on-axis spacing distance from an intersection point of an image-side surface of the sixth lens and the optical axis to a critical point of the image-side surface of the sixth lens, YT62 and a center thickness CT6 of the sixth lens satisfy: 0<YT62/CT6<0.6.

In an implementation mode, DISTnnax is a maximum optical distortion of the optical imaging lens group, when an F-number of the optical imaging lens group is maximum or minimum, DISTnnax satisfies: |DISTmax|<5%.

In an implementation mode, T45 is an on-axis spacing distance between the fourth lens and the fifth lens, T45 and a center thickness CT5 of the fifth lens on the optical axis satisfy: 1<T45/CT5<1.5.

In an implementation mode, TTL is an on-axis spacing distance between an object-side surface of the first lens and the imaging surface of the optical imaging lens group, TTL and InngH satisfy: TTL/ImgH<1.4.

Another embodiment of the disclosure provides an optical imaging lens group, which sequentially includes from an object side to an image side along an optical axis: a first lens with a positive refractive power, and an image-side surface of the first lens is a concave surface; a second lens with a refractive power, and an image-side surface of the second lens is a concave surface; a third lens with a refractive power; a fourth lens; a fifth lens with a refractive power, and an object-side surface of the fifth lens is a concave surface; a sixth lens with a positive refractive power, and an object-side surface of the sixth lens is a convex surface; a seventh lens with a negative refractive power, and an image-side surface of the seventh lens is a concave surface; and an iris diaphragm, the iris diaphragm is arranged between the first lens and the second lens, wherein ImgH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5; T45 is an on-axis spacing distance between the fourth lens and the fifth lens, T45 and a center thickness CT5 of the fifth lens on the optical axis satisfy: 1<T45/CT5<1.5.

In an implementation mode, an effective focal length f1 of the first lens and an effective focal length f6 of the sixth lens satisfy: 1<f1/f6<1.5.

In an implementation mode, T45 is an on-axis spacing distance between the fourth lens and the fifth lens, T56 is an on-axis spacing distance between the fifth lens and the sixth lens, and T45 and T56 satisfy: 3<T45/T56<3.5.

In an implementation mode, a curvature radius R14 of the image-side surface of the seventh lens and an effective focal length f of the optical imaging lens group satisfy: R14/f<0.5.

In an implementation mode, a curvature radius R11 of the object-side surface of the sixth lens and a curvature radius R14 of the image-side surface of the seventh lens satisfy: 0.9<R11/R14<1.3.

In an implementation mode, T45 is an on-axis spacing distance between the fourth lens and the fifth lens, a center thickness CT3 of the third lens on the optical axis, a center thickness CT4 of the fourth lens on the optical axis and T45 satisfy: 1<(CT3+CT4)/T45<1.5.

In an implementation mode, T56 is an on-axis spacing distance between the fifth lens and the sixth lens, T56 and a center thickness CT6 of the sixth lens on the optical axis satisfy: 0.2<T56/CT6<0.7.

In an implementation mode, a maximum effective radius DT21 of an object-side surface of the second lens and a maximum effective radius DT32 of an image-side surface of the third lens satisfy: 1<DT21/DT32<1.5.

In an implementation mode, a maximum effective radius DT72 of the image-side surface of the seventh lens and ImgH satisfy: 0.5<DT72/ImgH<1.

In an implementation mode, a maximum effective radius DT61 of the object-side surface of the sixth lens and a maximum effective radius DT52 of an image-side surface of the fifth lens satisfy: 0.2<(DT61−DT52)/DT52<0.6.

In an implementation mode, SAG52 is an on-axis spacing distance from an intersection point of an image-side surface of the fifth lens and the optical axis to an effective radius vertex of the image-side surface of the fifth lens, SAG52 and a center thickness CT5 of the fifth lens on the optical axis satisfy: −1.8<SAG52/CT5<−1.3.

In an implementation mode, SAG61 is an on-axis spacing distance from an intersection point of the object-side surface of the sixth lens and the optical axis to an effective radius vertex of the object-side surface of the sixth lens, T56 is an on-axis spacing distance between the fifth lens and the sixth lens, and SAG61 and T56 satisfy: −1.5<SAG61/T56<−1.

In an implementation mode, SAG72 is an on-axis spacing distance from an intersection point of the image-side surface of the seventh lens and the optical axis to an effective radius vertex of the image-side surface of the seventh lens, SAG72 and a center thickness CT7 of the seventh lens on the optical axis satisfy: −2<SAG72/CT7<−1.

In an implementation mode, YC72 is a vertical distance from a critical point of the image-side surface of the seventh lens to the optical axis, YC72 and a maximum effective radius DT72 of the image-side surface of the seventh lens satisfy: 0.1<YC72/DT72<0.5.

In an implementation mode, an edge thickness ET3 of the third lens at a maximum effective diameter and a center thickness CT3 of the third lens on the optical axis satisfy: 0.5<ET3/CT3<1.

In an implementation mode, an edge thickness ET4 of the fourth lens at the maximum effective diameter and a center thickness CT4 of the fourth lens on the optical axis satisfy: 0.9<ET4/CT4<1.3.

In an implementation mode, YT62 is an on-axis spacing distance from an intersection point of an image-side surface of the sixth lens and the optical axis to a critical point of the image-side surface of the sixth lens, YT62 and a center thickness CT6 of the sixth lens satisfy: 0<YT62/CT6<0.6.

In an implementation mode, DISTnnax is a maximum optical distortion of the optical imaging lens group, when an F-number of the optical imaging lens group is maximum or minimum, DISTnnax satisfies: |DISTmax|<5%.

In an implementation mode, SAG51 is an on-axis spacing distance from an intersection point of the object-side surface of the fifth lens and the optical axis to an effective radius vertex of the object-side surface of the fifth lens, SAG51 and a center thickness CT5 of the fifth lens on the optical axis satisfy: −1.5<SAG51/CT5<−1.

In an implementation mode, TTL is an on-axis spacing distance between an object-side surface of the first lens and the imaging surface of the optical imaging lens group, TTL and InngH satisfy: TTL/ImgH<1.4.

By applying the technical solutions of the disclosure, the optical imaging lens group sequentially includes from an object side to an image side along an optical axis: a first lens, a second lens, a third lens, a fourth lens, a fifth lens, a sixth lens, a seventh lens and an iris diaphragm, wherein the first lens has a positive refractive power, and an image-side surface of the first lens is a concave surface; the second lens has a refractive power, and an image-side surface of the second lens is a concave surface; the third lens has a refractive power; the fifth lens has a refractive power, and an object-side surface of the fifth lens is a concave surface; the sixth lens has a positive refractive power, and an object-side surface of the sixth lens is a convex surface; the seventh lens has a negative refractive power, and an image-side surface of the seventh lens is a concave surface; and the iris diaphragm is arranged between the first lens and the second lens. Fno2 is an F-number when an object distance of the optical imaging lens group is 1000 mm, Fno1 is an F-number when the object distance of the optical imaging lens group is 7000 mm satisfy: 1.3<Fno2/Fno1<1.8; InngH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5.

By disposing the iris diaphragm on the optical imaging lens group, an optical system has a function of variable apertures, which may achieve image quality balance under different apertures. The aperture may be adjusted when adapting to changes in ambient brightness, so as to ensure stable image quality and brightness. By constraining a relationship between an image height and the maximum field of view, an imaging quality of the optical imaging lens group may be guaranteed, so that miniaturization and high-quality imaging may coexist. By limiting the ratios of the F numbers of the optical imaging lens group under different object distances, the imaging quality of the optical imaging lens group may be greatly improved.

### BRIEF DESCRIPTION OF THE DRAWINGS

The drawings constituting a part of the disclosure are used for providing a further understanding of the disclosure, and exemplary embodiments of the disclosure and descriptions thereof are used for explaining the disclosure, but do not constitute improper limitations of the disclosure. In the drawings:

FIG. 1 shows a structural schematic diagram of an optical imaging lens group of Example 1 of the disclosure when an object distance is 7000 mm;

FIGS. 2-5 respectively show a longitudinal aberration curve, an astigmatism curve, a distortion curve and a lateral color curve of the optical imaging lens group in FIG. 1;

FIG. 6 shows a structural schematic diagram of the optical imaging lens group of Example 1 of the disclosure when the object distance is 1000 mm;

FIGS. 7-10 respectively show a longitudinal aberration curve, an astigmatism curve, a distortion curve and a lateral color curve of the optical imaging lens group in FIG. 6;

FIG. 11 shows a structural schematic diagram of an optical imaging lens group of Example 2 of the disclosure when the object distance is 7000 mm;

FIGS. 12-15 respectively show a longitudinal aberration curve, an astigmatism curve, a distortion curve and a lateral color curve of the optical imaging lens group in FIG. 11;

FIG. 16 shows a structural schematic diagram of the optical imaging lens group of Example 2 of the disclosure when the object distance is 1000 mm;

FIGS. 17-20 respectively show a longitudinal aberration curve, an astigmatism curve, a distortion curve and a lateral color curve of the optical imaging lens group in FIG. 16;

FIG. 21 shows a structural schematic diagram of an optical imaging lens group of Example 3 of the disclosure when the object distance is 7000 mm;

FIGS. 22-25 respectively show a longitudinal aberration curve, an astigmatism curve, a distortion curve and a lateral color curve of the optical imaging lens group in FIG. 21;

FIG. 26 shows a structural schematic diagram of the optical imaging lens group of Example 3 of the disclosure when the object distance is 1000 mm;

FIGS. 27-30 respectively show a longitudinal aberration curve, an astigmatism curve, a distortion curve and a lateral color curve of the optical imaging lens group in FIG. 26;

FIG. 31 shows a structural schematic diagram of an optical imaging lens group of Example 4 of the disclosure when the object distance is 7000 mm;

FIGS. 32-35 respectively show a longitudinal aberration curve, an astigmatism curve, a distortion curve and a lateral color curve of the optical imaging lens group in FIG. 31;

FIG. 36 shows a structural schematic diagram of the optical imaging lens group of Example 4 of the disclosure when the object distance is 1000 mm;

FIGS. 37-40 respectively show a longitudinal aberration curve, an astigmatism curve, a distortion curve and a lateral color curve of the optical imaging lens group in FIG. 36;

FIG. 41 shows a structural schematic diagram of an optical imaging lens group of Example 5 of the disclosure when the object distance is 7000 mm;

FIGS. 42-45 respectively show a longitudinal aberration curve, an astigmatism curve, a distortion curve and a lateral color curve of the optical imaging lens group in FIG. 41;

FIG. 46 shows a structural schematic diagram of the optical imaging lens group of Example 5 of the disclosure when the object distance is 1000 mm; and

FIGS. 47-50 respectively show a longitudinal aberration curve, an astigmatism curve, a distortion curve and a lateral color curve of the optical imaging lens group in FIG. 46.

The above drawings include the following reference signs:

STO, an iris diaphragm; E1, a first lens; S1, an object-side surface of the first lens; S2, an image-side surface of the first lens; E2, a second lens; S3, an object-side surface of the second lens; S4, an image-side surface of the second lens; E3, a third lens; S5, an object-side surface of the third lens; S6, an image-side surface of the third lens; E4, a fourth lens; S7, an object-side surface of the fourth lens; S8, an image-side surface of the fourth lens; E5, a fifth lens; S9, an object-side surface of the fifth lens; S10, an image-side surface of the fifth lens; E6, a sixth lens; S11, an object-side surface of the sixth lens; S12, an image-side surface of the sixth lens; E7, a seventh lens; S13, an object-side surface of the seventh lens; S14, an image-side surface of the seventh lens; E8, a filter; S15, an object-side surface of the filter; S16, an image-side surface of the filter; S17, an imaging surface.

### DETAILED DESCRIPTION OF THE EMBODIMENTS

It should be noted that, if there is no conflict, embodiments in the disclosure and features in the embodiments may be combined with each other. Hereinafter, the disclosure will be described in detail with reference to the drawings and in conjunction with the embodiments.

It should be pointed out that, unless otherwise specified, all technical and scientific terms used in the disclosure have the same meanings as commonly understood by those of ordinary skill in the technical field to which the disclosure belongs.

In the disclosure, unless otherwise stated, orientation words used such as “up, down, top and bottom” are usually directed to directions shown in the drawings, or are directed to vertical, perpendicular or gravitational directions of components themselves; and similarly, for the convenience of understanding and description, “inside and outside” refer to inside and outside relative to the contours of the components themselves, but the above-mentioned orientation words are not used for limiting the disclosure.

It should be noted that in the disclosure, the expressions of first, second, third and the like are only used to distinguish one feature from another feature, but do not imply any limitation on the feature. Accordingly, without departing from the teachings of the disclosure, a first lens discussed below may also be referred to as a second lens or a third lens.

In the drawings, for the convenience of illustration, the thickness, size and shape of the lens have been slightly exaggerated. Specifically, spherical or aspheric shapes shown in the drawings are shown by way of examples. That is, the spherical or aspheric shapes are not limited to the spherical or aspheric shapes shown in the drawings. The drawings are examples only and are not drawn strictly to scale.

Herein, a paraxial area refers to an area in the vicinity of an optical axis. If a lens surface is a convex surface and the position of the convex surface is not defined, it means that the lens surface is a convex surface at least in the paraxial area; and if the lens surface is a concave surface and the position of the concave surface is not defined, it means that the lens surface is a concave surface at least in the paraxial area. A surface of each lens close to an object side becomes an object-side surface of the lens, and a surface of each lens close to an image side is called an image-side surface of the lens. The surface shape of the paraxial area may be determined according to determination manners of those of ordinary skill in the art, and concave and convex are determined by an R value (R refers to a curvature radius of the paraxial area, and usually refers to the R value on a lens database (lens data) in optical software). With regard to the object-side surface, when the R value is positive, it is determined to be a convex surface, and when the R value is negative, it is determined to be a concave surface; and with regard to the image-side surface, when the R value is positive, it is determined to be a concave surface, and when the R value is negative, it is determined to be a convex surface.

In order to solve the problem in the related art that it is not easy to realize a miniaturization of a camera lens, the disclosure provides an optical imaging lens group.

### Embodiment 1

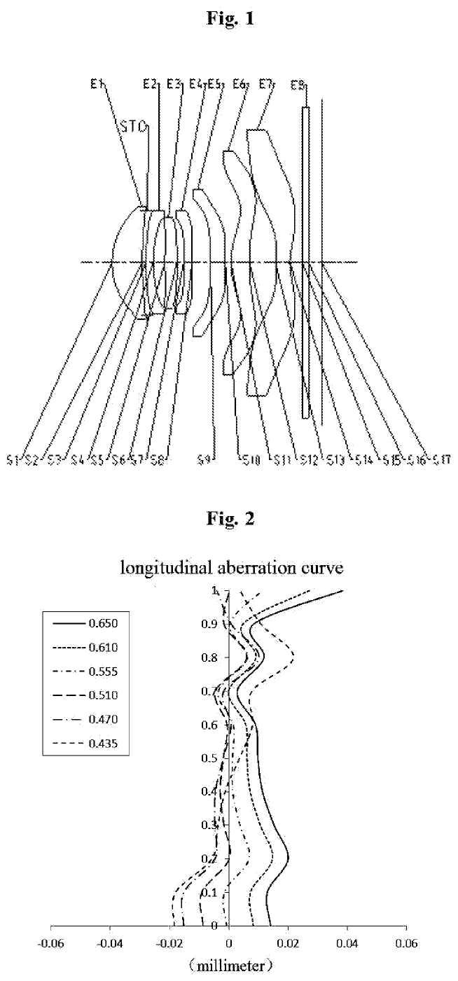

As shown in FIGS. 1-50, an optical imaging lens group sequentially includes from an object side to an image side along an optical axis: a first lens, a second lens, a third lens, a fourth lens, a fifth lens, a sixth lens, a seventh lens and an iris diaphragm, wherein the first lens has a positive refractive power, and an image-side surface of the first lens is a concave surface; the second lens has a refractive power, and an image-side surface of the second lens is a concave surface; the third lens has a refractive power; the fifth lens has a refractive power, and an object-side surface of the fifth lens is a concave surface; the sixth lens has a positive refractive power, and an object-side surface of the sixth lens is a convex surface; the seventh lens has a negative refractive power, and an image-side surface of the seventh lens is a concave surface; and the iris diaphragm is arranged between the first lens and the second lens. Fno2 is an F-number when an object distance of the optical imaging lens group is 1000 mm, and Fno1 is an F-number when the object distance of the optical imaging lens group is 7000 mm, and Fno2 and Fno1 satisfy: 1.3<Fno2/Fno1<1.8; InngH is a half of a diagonal length of an effective pixel region on an imaging surface of the optical imaging lens group, FOV is a maximum field of view of the optical imaging lens group, and InngH and FOV satisfy: 4.5<ImgH*tan(FOV/2)<5.5.

By disposing the iris diaphragm on the optical imaging lens group, an optical system has a function of variable apertures, which may achieve image quality balance under different apertures. The aperture may be adjusted when adapting to changes in ambient brightness, so as to ensure stable image quality and brightness. By constraining a relationship between an image height and the maximum field of view, an imaging quality of the optical imaging lens group may be guaranteed, so that miniaturization and high-quality imaging may coexist. By limiting the ratios of the F numbers of the optical imaging lens group under different object distances, the imaging quality of the optical imaging lens group may be greatly improved.

More specifically, ImgH and the maximum field of view (FOV) satisfy: 4.9<ImgH*tan(FOV/2)<5.1; and Fno2 and Fno1 satisfy: 1.5<Fno2/Fno1<1.6.

In the embodiment, TTL is an on-axis spacing distance between the object-side surface of the first lens and the imaging surface of the optical imaging lens group, and TTL and ImgH satisfy: TTL/ImgH<1.4. By reasonably constraining a ratio of a total length to an image height of the optical imaging lens group, it is beneficial for a miniaturization of the optical imaging lens group. More specifically, 1.25<TTL/ImgH<1.35.

In the embodiment, an effective focal length f1 of the first lens and an effective focal length f6 of the sixth lens satisfy: 1<f1/f6<1.5. By constraining the focal lengths of the first lens and the sixth lens, the first lens may improve an ability to focus light, and it is also conducive to reducing an aberration of the optical imaging lens group. More specifically, 1.2<f1/f6<1.3.

In the embodiment, T45 is an on-axis spacing distance between the fourth lens and the fifth lens, T56 is an on-axis spacing distance between the fifth lens and the sixth lens, and T45 and T56 satisfy: 3<T45/T56<3.5. By reasonably controlling a relative position of the fourth lens and the fifth lens on the optical axis, an ability of the optical imaging lens group to correct astigmatism and field curvature may be improved. More specifically, 3<T45/T56<3.3.

In the embodiment, a curvature radius R14 of an image-side surface of the seventh lens and an effective focal length f of the optical imaging lens group satisfy: R14/f<0.5. By constraining a ratio of the effective focal length of the optical imaging lens group to the curvature radius of the image-side surface of the seventh lens, a sensitivity of the overall optical system may be effectively reduced, and a sensitivity of the seventh lens to field curvature may be reduced at the same time. More specifically, 0.3≤R14/f<0.5.

In the embodiment, a curvature radius R11 of an object-side surface of the sixth lens and a curvature radius R14 of an image-side surface of the seventh lens satisfy: 0.9<R11/R14<1.3. Such a setting helps to reduce an aberration of the optical imaging lens group at two apertures, so that the optical imaging lens group has a better ability to balance chromatic aberration and distortion at the two apertures. More specifically, 1.0<R11/R14<1.2.

In the embodiment, T45 is an on-axis spacing distance between the fourth lens and the fifth lens, a center thickness CT3 of the third lens on the optical axis, a center thickness CT4 of the fourth lens on the optical axis and T45 satisfy: 1<(CT3+CT4)/T45<1.5. By means of such a setting, a size of a rear end of the optical imaging lens group may be effectively reduced, thereby avoiding an excessively large volume of the optical imaging lens group, which is beneficial for a miniaturization of the optical imaging lens group. At the same time, an assembly difficulty of the first four lenses may be reduced, and a higher space utilization rate may also be realized. More specifically, 1.1<(CT3+CT4)/T45<1.2.

In the embodiment, T56 is an on-axis spacing distance between the fifth lens and the sixth lens, T56 and a center thickness CT6 of the sixth lens on the optical axis satisfy: 0.2<T56/CT6<0.7. By means of such a setting, there is an enough space between the fifth lens and the sixth lens, so that a varying degree of freedom of the lens surface is higher, and then an ability of the optical system to correct field curvature is improved. More specifically, 0.25<T56/CT6<0.4.

In the embodiment, a maximum effective radius DT21 of an object-side surface of the second lens and a maximum effective radius DT32 of an image-side surface of the third lens satisfy: 1<DT21/DT32<1.5. By reasonably controlling effective apertures of the second lens and the third lens, a varying degree of freedom of the lens surface is higher, and a size of the system may also be reduced at the same time, which is beneficial for a miniaturization of the optical imaging lens group. More specifically, 1.1<DT21/DT32<1.3.

In the embodiment, a maximum effective radius DT72 of the image-side surface of the seventh lens and ImgH satisfy: 0.5<DT72/ImgH<1. By controlling the effective radius of the seventh lens, the overall size of the optical imaging lens group may be ensured, and meanwhile, when the aperture is switched, the size of the optical imaging lens group may be kept stable. More specifically, 0.8<DT72/ImgH<0.9.

In the embodiment, a maximum effective radius DT61 of an object-side surface of the sixth lens and a maximum effective radius DT52 of an image-side surface of the fifth lens satisfy: 0.2<(DT61−DT52)/DT52<0.6. By controlling a ratio of optical apertures of the fifth lens and the sixth lens, the optical imaging lens group may ensure a normal light transition and a normal and stable deflection angle when the double apertures are switched. More specifically, 0.4<(DT61−DT52)/DT52<0.5.

In the embodiment, SAG51 is an on-axis spacing distance from an intersection point of the object-side surface of the fifth lens and the optical axis to an effective radius vertex of the object-side surface of the fifth lens, SAG51 and a center thickness CT5 of the fifth lens on the optical axis satisfy: −1.5<SAG51/CT5<−1. By controlling a positional relationship of the fifth lens on the optical axis, a moulding production process of the fifth lens may be ensured, and meanwhile, a field curvature may be effectively reduced optically. More specifically, −1.2<SAG51/CT5<−1.1.

In the embodiment, SAG52 is an on-axis spacing distance from an intersection point of an image-side surface of the fifth lens and the optical axis to an effective radius vertex of the image-side surface of the fifth lens, SAG52 and a center thickness CT5 of the fifth lens on the optical axis satisfy: −1.8<SAG52/CT5<−1.3. By controlling a positional relationship of the fifth lens on the optical axis, a problem of field curvature sensitivity of the entire optical imaging lens group is effectively improved, and a contribution of the fifth lens to an astigmatism and coma of the entire optical imaging lens group is reduced. More specifically, −1.7<SAG52/CT5<−1.5.

In the embodiment, SAG61 is an on-axis spacing distance from an intersection point of the object-side surface of the sixth lens and the optical axis to an effective radius vertex of the object-side surface of the sixth lens, T56 is an on-axis spacing distance between the fifth lens and the sixth lens, and SAG61 and T56 satisfy: −1.5<SAG61/T56<−1. By means of such a setting, a ghost image risk brought by the fifth lens and the sixth lens may be effectively weakened, and at the same time, a size of the optical imaging lens group may be reduced, such that the optical imaging lens group is more miniaturized. More specifically, −1.4<SAG61/T56<−1.2.

In the embodiment, SAG72 is an on-axis spacing distance from an intersection point of the image-side surface of the seventh lens and the optical axis to an effective radius vertex of the image-side surface of the seventh lens, SAG72 and a center thickness CT7 of the seventh lens on the optical axis satisfy: −2<SAG72/CT7<−1. By reasonably controlling a vector height of the seventh lens, it is conducive to limiting a curvature of the seventh lens, reducing a processing and moulding difficulty and a deformation risk of the seventh lens, and improving an image quality at the same time. More specifically, −1.9<SAG72/CT7<−1.6.

In the embodiment, YC72 is a vertical distance from a critical point of the image-side surface of the seventh lens to the optical axis, YC72 and a maximum effective radius DT72 of the image-side surface of the seventh lens satisfy: 0.1<YC72/DT72<0.5. By reasonably controlling a geometric size of the seventh lens, a size of the optical imaging lens group may be effectively ensured, and a vertical axis aberration of the optical imaging lens group is reduced. More specifically, 0.3<YC72/DT72<0.4.

In the embodiment, an edge thickness ET3 of the third lens at a maximum effective diameter and a center thickness CT3 of the third lens on the optical axis satisfy: 0.5<ET3/CT3<1. By means of such a setting, it is conducive to reducing an aberration of the optical imaging lens group, so as to make it easier to implement a double-aperture system. Moreover, it has a function of adjusting a light position, and a total length of the optical imaging lens group is shortened, which is beneficial for a miniaturization of the optical imaging lens group. More specifically, 0.6<ET3/CT3<0.7.

In the embodiment, an edge thickness ET4 of the fourth lens at a maximum effective diameter and a center thickness CT4 of the fourth lens on the optical axis satisfy: 0.9<ET4/CT4<1.3. By means of such a setting, the fourth lens has a sufficient thickness, thereby reducing a tolerance sensitivity of the fourth lens, and a processing characteristic is thus improved. More specifically, 1.1<ET4/CT4<1.2.

In the embodiment, YT62 is an on-axis spacing distance from an intersection point of an image-side surface of the sixth lens and the optical axis to a critical point of the image-side surface of the sixth lens, YT62 and a center thickness CT6 of the sixth lens satisfy: 0<YT62/CT6<0.6. By controlling a relative position of the sixth lens on the optical axis, light of the optical imaging lens group may pass smoothly under the double apertures, and meanwhile, a deflection angle of the sixth lens may also be reduced, such that an optical sensitivity of the sixth lens is reduced. More specifically, 0.3<YT62/CT6<0.4.

In the embodiment, DISTmax is a maximum optical distortion of the optical imaging lens group, when an F-number of the optical imaging lens group is maximum or minimum, DISTmax satisfies: |DISTmax|<5%. Under a condition of double apertures, a distortion of each state may be kept at a smaller level, so as to realize a stability of a picture. More specifically, 1.9%<|DISTmax|<2%.

In the embodiment, T45 is an on-axis spacing distance between the fourth lens and the fifth lens, T45 and a center thickness CT5 of the fifth lens on the optical axis satisfy: 1<T45/CT5<1.5. By constraining a thickness relationship between the fourth lens and the fifth lens, a miniaturization of the optical imaging lens group is facilitated. More specifically, 1.2<T45/CT5<1.3.

### Embodiment 2

As shown in FIGS. 1-50, an optical imaging lens group sequentially includes from an object side to an image side along an optical axis: a first lens, a second lens, a third lens, a fourth lens, a fifth lens, a sixth lens, a seventh lens and an iris diaphragm, wherein the first lens has a positive refractive power, and an image-side surface of the first lens is a concave surface; the second lens has a refractive power, and an image-side surface of the second lens is a concave surface; the third lens has a refractive power; the fifth lens has a refractive power, and an object-side surface of the fifth lens is a concave surface; the sixth lens has a positive refractive power, and an object-side surface of the sixth lens is a convex surface; the seventh lens has a negative refractive power, and an image-side surface of the seventh lens is a concave surface; and the iris diaphragm is arranged between the first lens and the second lens. IrrigH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5; T45 is an on-axis spacing distance between the fourth lens and the fifth lens, T45 and a center thickness CT5 of the fifth lens on the optical axis satisfy: 1<T45/CT5<1.5.

By reasonably distributing a surface shape and focal power of each lens, a tolerance sensitivity of each lens is reduced, an aberration of an optical imaging lens is reduced, and higher imaging quality of the optical imaging lens is guaranteed. By disposing the iris diaphragm on the optical imaging lens group, an optical system has a function of variable apertures, which may achieve image quality balance under different apertures. The aperture may be adjusted when adapting to changes in ambient brightness, so as to ensure stable image quality and brightness. By constraining a thickness relationship between the fourth lens and the fifth lens, a miniaturization of the optical imaging lens group is facilitated. By limiting ratios of the F numbers of the optical imaging lens group under different object distances, an imaging quality of the optical imaging lens group may be greatly improved.

More specifically, ImgH and the maximum field of view (FOV) satisfy: 4.9<ImgH*tan(FOV/2)<5.1; and T45 and CT5 satisfy: 1.2<T45/CT5<1.3.

In the embodiment, TTL is an on-axis spacing distance between an object-side surface of the first lens and the imaging surface of the optical imaging lens group, TTL and ImgH satisfy: TTL/ImgH<1.4. By reasonably constraining a ratio of a total length to an image height of the optical imaging lens group, it is beneficial for a miniaturization of the optical imaging lens group. More specifically, 1.25<TTL/ImgH<1.35.

In the embodiment, an effective focal length f1 of the first lens and an effective focal length f6 of the sixth lens satisfy: 1<f1/f6<1.5. By constraining focal lengths of the first lens and the sixth lens, the first lens may improve an ability to focus light, and it is also conducive to reducing an aberration of the optical imaging lens group. More specifically, 1.2<f1/f6<1.3.

In the embodiment, T45 is an on-axis spacing distance between the fourth lens and the fifth lens, T56 is an on-axis spacing distance between the fifth lens and the sixth lens, and T45 and T56 satisfy: 3<T45/T56<3.5. By reasonably controlling a relative position of the fourth lens and the fifth lens on the optical axis, an ability of the optical imaging lens group to correct astigmatism and field curvature may be improved. More specifically, 3<T45/T56<3.3.

In the embodiment, a curvature radius R14 of the image-side surface of the seventh lens and an effective focal length f of the optical imaging lens group satisfy: R14/f<0.5. By constraining a ratio of the effective focal length of the optical imaging lens group to the curvature radius of the image-side surface of the seventh lens, a sensitivity of the overall optical system may be effectively reduced, and a sensitivity of the seventh lens to field curvature may be reduced at the same time. More specifically, 0.3≤R14/f<0.5.

In the embodiment, a curvature radius R11 of the object-side surface of the sixth lens and a curvature radius R14 of the image-side surface of the seventh lens satisfy: 0.9<R11/R14<1.3. Such a setting helps to reduce an aberration of the optical imaging lens group at two apertures, so that the optical imaging lens group has a better ability to balance chromatic aberration and distortion at the two apertures. More specifically, 1.0<R11/R14<1.2.

In the embodiment, T45 is an on-axis spacing distance between the fourth lens and the fifth lens, a center thickness CT3 of the third lens on the optical axis, a center thickness CT4 of the fourth lens on the optical axis and T45 satisfy: 1<(CT3+CT4)/T45<1.5. By means of such a setting, a size of a rear end of the optical imaging lens group may be effectively reduced, thereby avoiding an excessively large volume of the optical imaging lens group, which is beneficial for a miniaturization of the optical imaging lens group. At the same time, an assembly difficulty of the first four lenses may be reduced, and a higher space utilization rate may also be realized. More specifically, 1.1<(CT3+CT4)/T45<1.2.

In the embodiment, T56 is an on-axis spacing distance between the fifth lens and the sixth lens, T56 and a center thickness CT6 of the sixth lens on the optical axis satisfy: 0.2<T56/CT6<0.7. By means of such a setting, there is an enough space between the fifth lens and the sixth lens, so that a varying degree of freedom of the lens surface is higher, and then an ability of the optical system to correct field curvature is improved. More specifically, 0.25<T56/CT6<0.4.

In the embodiment, a maximum effective radius DT21 of an object-side surface of the second lens and a maximum effective radius DT32 of an image-side surface of the third lens satisfy: 1<DT21/DT32<1.5. By reasonably controlling effective apertures of the second lens and the third lens, a varying degree of freedom of the lens surface is higher, and a size of the system may also be reduced at the same time, which is beneficial for a miniaturization of the optical imaging lens group. More specifically, 1.1<DT21/DT32<1.3.

In the embodiment, a maximum effective radius DT72 of the image-side surface of the seventh lens and ImgH satisfy: 0.5<DT72/ImgH<1. By controlling the effective radius of the seventh lens, the overall size of the optical imaging lens group may be ensured, and meanwhile, when the aperture is switched, the size of the optical imaging lens group may be kept stable. More specifically, 0.8<DT72/ImgH<0.9.

In the embodiment, a maximum effective radius DT61 of an object-side surface of the sixth lens and a maximum effective radius DT52 of an image-side surface of the fifth lens satisfy: 0.2<(DT61−DT52)/DT52<0.6. By controlling a ratio of optical apertures of the fifth lens and the sixth lens, the optical imaging lens group may ensure a normal light transition and a normal and stable deflection angle when the double apertures are switched. More specifically, 0.4<(DT61−DT52)/DT52<0.5.

In the embodiment, SAG52 is an on-axis spacing distance from an intersection point of an image-side surface of the fifth lens and the optical axis to an effective radius vertex of the image-side surface of the fifth lens, SAG52 and a center thickness CT5 of the fifth lens on the optical axis satisfy: −1.8<SAG52/CT5<−1.3. By controlling a positional relationship of the fifth lens on the optical axis, a problem of field curvature sensitivity of the entire optical imaging lens group is effectively improved, and a contribution of the fifth lens to an astigmatism and coma of the entire optical imaging lens group is reduced. More specifically, −1.7<SAG52/CT5<−1.5.

In the embodiment, SAG61 is an on-axis spacing distance from an intersection point of the object-side surface of the sixth lens and the optical axis to an effective radius vertex of the object-side surface of the sixth lens, T56 is an on-axis spacing distance between the fifth lens and the sixth lens, and SAG61 and T56 satisfy: −1.5<SAG61/T56<−1. By means of such a setting, a ghost image risk brought by the fifth lens and the sixth lens may be effectively weakened, and at the same time, a size of the optical imaging lens group may be reduced, such that the optical imaging lens group is more miniaturized. More specifically, −1.4<SAG61/T56<−1.2.

In the embodiment, SAG72 is an on-axis spacing distance from an intersection point of the image-side surface of the seventh lens and the optical axis to an effective radius vertex of the image-side surface of the seventh lens, SAG72 and a center thickness CT7 of the seventh lens on the optical axis satisfy: −2<SAG72/CT7<−1. By reasonably controlling a vector height of the seventh lens, it is conducive to limiting a curvature of the seventh lens, reducing a processing and moulding difficulty and a deformation risk of the seventh lens, and improving an image quality at the same time. More specifically, −1.9<SAG72/CT7<−1.6.

In the embodiment, YC72 is a vertical distance from a critical point of the image-side surface of the seventh lens to the optical axis, YC72 and a maximum effective radius DT72 of the image-side surface of the seventh lens satisfy: 0.1<YC72/DT72<0.5. By reasonably controlling the geometric size of the seventh lens, a size of the optical imaging lens group may be effectively ensured, and a vertical axis aberration of the optical imaging lens group is reduced. More specifically, 0.3<YC72/DT72<0.4.

In the embodiment, an edge thickness ET3 of the third lens at a maximum effective diameter and a center thickness CT3 of the third lens on the optical axis satisfy: 0.5<ET3/CT3<1. By means of such a setting, it is conducive to reducing an aberration of the optical imaging lens group, so as to make it easier to implement a double-aperture system. Moreover, it has a function of adjusting a light position, and a total length of the optical imaging lens group is shortened, which is beneficial for a miniaturization of the optical imaging lens group. More specifically, 0.6<ET3/CT3<0.7.

In the embodiment, an edge thickness ET4 of the fourth lens at the maximum effective diameter and a center thickness CT4 of the fourth lens on the optical axis satisfy: 0.9<ET4/CT4<1.3. By means of such a setting, the fourth lens has a sufficient thickness, thereby reducing a tolerance sensitivity of the fourth lens, and a processing characteristic is thus improved. More specifically, 1.1<ET4/CT4<1.2.

In the embodiment, YT62 is an on-axis spacing distance from an intersection point of an image-side surface of the sixth lens and the optical axis to a critical point of the image-side surface of the sixth lens, YT62 and a center thickness CT6 of the sixth lens satisfy: 0<YT62/CT6<0.6. By controlling a relative position of the sixth lens on the optical axis, the light of the optical imaging lens group may pass smoothly under the double apertures, and meanwhile, a deflection angle of the sixth lens may also be reduced, such that an optical sensitivity of the sixth lens is reduced. More specifically, 0.3<YT62/CT6<0.4.

In the embodiment, DISTmax is a maximum optical distortion of the optical imaging lens group, when an F-number of the optical imaging lens group is maximum or minimum, DISTmax satisfies: |DISTmax|<5%. Under a condition of double apertures, a distortion of each state may be kept at a smaller level, so as to realize a stability of a picture. More specifically, 1.9%<|DISTmax|<2%.

In the embodiment, SAG51 is an on-axis spacing distance from an intersection point of the object-side surface of the fifth lens and the optical axis to the effective radius vertex of the object-side surface of the fifth lens, SAG51 and a center thickness CT5 of the fifth lens on the optical axis satisfy: −1.5<SAG51/CT5<−1. By controlling a positional relationship of the fifth lens on the optical axis, a moulding production process of the fifth lens may be ensured, and meanwhile, a field curvature may be effectively reduced optically. More specifically, −1.2<SAG51/CT5<−1.1.

In an embodiment, the above-mentioned optical imaging lens group may further include a filter for correcting color deviation and/or a protective glass for protecting a photosensitive element that is located on the imaging surface.

The optical imaging lens group in the disclosure may use a plurality of lenses, for example, the above-mentioned seven lenses. By reasonably distributing a focal power, a surface shape and a center thickness of each lens and an on-axis spacing distance between the lenses and the like, an aperture of the optical imaging lens group may be effectively increased, a sensitivity of the lens may be reduced, and a machinability of the lenses may be improved. Therefore, the optical imaging lens group is more conducive to production and processing and may be applicable to portable electronic devices such as smart phones. The above-mentioned optical imaging lens group further has advantages of large aperture, large field angle, ultra-thinness and good imaging quality, and thus may satisfy the needs of miniaturization of intelligent electronic products.

In the disclosure, at least one of lens surfaces of each lens is an aspheric lens surface. An aspheric lens is characterized in that, from the center of the lens to the periphery of the lens, the curvature changes continuously. Unlike a spherical lens, which has a constant curvature from the center of the lens to the periphery of the lens, the aspheric lens has better curvature radius characteristics, and has the advantages of improving distorted optical aberration and astigmatic aberration. After the aspheric lens is used, the optical aberration that occurs during imaging may be eliminated as much as possible, thereby improving the imaging quality.

However, those skilled in the art should understand that, without departing from the technical solutions claimed by the disclosure, the number of lenses constituting the optical imaging lens group may be changed to obtain various results and advantages described in this specification. For example, although seven lenses are described as an example in the embodiments, the optical imaging lens group is not limited to including seven lenses. As needed, the optical imaging lens set may also include other numbers of lenses.

Examples of specific surface shapes and parameters of the optical imaging lens group applicable to the above-mentioned embodiments will be further described below with reference to the drawings.

It should be noted that, any one of the following Examples 1 to 5 is applicable to all the embodiments of the disclosure.

### EXAMPLE 1

As shown in FIGS. 1-10, an optical imaging lens group of Example 1 of the disclosure is described. FIG. 1 shows a structural schematic diagram of the optical imaging lens group of Example 1 when an object distance is 7000 mm, and FIG. 6 shows a structural schematic diagram of the optical imaging lens group of Example 1 when the object distance is 1000 mm.

As shown in FIG. 1 and FIG. 6, the optical imaging lens group sequentially includes from an object side to an image side: a first lens E1, an iris diaphragm STO, a second lens E2, a third lens E3, a fourth lens E4, a fifth lens E5, a sixth lens E6, a seventh lens E7, a filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a negative refractive power, an object-side surface S9 of the fifth lens is a concave surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The filter E8 has an object-side surface S15 of the filter and an image-side surface S16 of the filter. Light from an object sequentially passes through the surfaces S1 to S16 and is finally imaged on the imaging surface S17.

In the example, a total effective focal length f of the optical imaging lens group is 5.89 mm, when the object distance of the optical imaging lens group is 7000 mm, a maximum field of view (FOV) is 84.4°, TTL is 7.00 mm, and Fno is 1.59; and when the object distance of the optical imaging lens group is 1000 mm, the maximum field of view (FOV) is 84.4°, TTL is 7.03 mm, and Fno is 2.44.

Table 1 shows a basic structural parameter table of the optical imaging lens group of Example 1, wherein the units of curvature radius, thickness/distance and focal length are all millimeters (mm).

TABLE 1

| | | | | Material | | |
|---|---|---|---|---|---|---|
| Surface | Surface | Curvature | | Refractive | Abbe | Conic |
| number | type | radius | Thickness | index | number | coefficient |
| OBJ | Spherical | Infinite | OT | | | |
| S1 | Aspheric | 2.3813 | 1.0087 | 1.55 | 56.1 | −0.9149 |
| S2 | Aspheric | 11.203 | 0.2150 | | | 16.4135 |
| STO | Spherical | Infinite | −0.1529 | | | |
| S3 | Aspheric | 7.6247 | 0.2480 | 1.67 | 20.4 | −4.4219 |
| S4 | Aspheric | 4.0034 | 0.4439 | | | −0.3816 |
| S5 | Aspheric | 25.0591 | 0.4047 | 1.57 | 37.3 | −99.0000 |
| S6 | Aspheric | −62.9694 | 0.2230 | | | 8.1105 |
| S7 | Aspheric | 17.2476 | 0.2859 | 1.67 | 20.4 | −3.4457 |
| S8 | Aspheric | 12.1221 | 0.6121 | | | 16.5206 |
| S9 | Aspheric | −28.1791 | 0.4873 | 1.57 | 37.3 | 0.0000 |
| S10 | Aspheric | 6.4208 | 0.1902 | | | 0.0000 |
| S11 | Aspheric | 2.0236 | 0.6246 | 1.55 | 56.1 | −1.0000 |
| S12 | Aspheric | 11.7085 | 0.8720 | | | 0.0000 |
| S13 | Aspheric | 6.6389 | 0.4752 | 1.54 | 55.7 | −0.2134 |
| S14 | Aspheric | 1.7980 | 0.4176 | | | −9.2650 |
| S15 | Spherical | Infinite | 0.2100 | 1.52 | 64.2 | |
| S16 | Spherical | Infinite | D1 | | | |
| S17 | Spherical | Infinite | | | | |

D1 is shown in Table 2.

TABLE 2

| | | |
|---|---|---|
| OT | 7000 | 1000 |
| D1 | 0.4346 | 0.4636 |

In Example 1, the object-side surface and the image-side surface of any one of the first lens E1 to the seventh lens E7 are both aspheric, and the surface shape of each aspheric lens may be defined by, but is not limited to, the following aspheric formula:

$$x = \frac{{ch}^{2}}{1 + \sqrt{1 - ( k + 1 ) {c}^{2} {h}^{2}}} + \sum {Aih}^{i} \qquad Formula ( 1 )$$

wherein x is a vector height of a distance between the, aspheric surface and a vertex of the aspheric surface when the aspheric surface is located at a position with the height h in the optical axis direction; c is a paraxial curvature of the aspheric surface, c=1/R (that is, the paraxial curvature c is a reciprocal of the curvature radius R in the above Table 1); k is a conic coefficient; and Ai is a correction coefficient of the i-th order of the aspheric surface. Table 3 below gives high-order coefficients A4, A6, A8, A10, A12, A14, A16, A18, A20, A22, A24, A26, A28 and A30 that may be used for the various aspheric lens surfaces S1-S14 in Example 1.

TABLE 3

| Surface number | A4 | A6 | A8 | A10 | A12 | A14 | A16 |
|---|---|---|---|---|---|---|---|
| S1 | 4.5383E−03 | 3.0637E−02 | −1.1388E−01 | 2.7692E−01 | 4.5276E−01 | 5.1802E−01 | −4.2434E−01 |
| S2 | −1.9192E−02 | 7.9968E−03 | 2.6997E−02 | −2.5955E−02 | −1.0813E−01 | 3.5307E−01 | −5.1804E−01 |
| S3 | −2.5735E−02 | −6.6079E−02 | 5.4969E−01 | −1.8858E+00 | 4.1015E+00 | −6.1012E+00 | 6.4111E+00 |
| S4 | −2.1483E−02 | 7.2789E−02 | −4.1065E−01 | 1.7122E+00 | −4.5045E+00 | 7.7896E+00 | −9.1255E+00 |
| S5 | −9.7591E−04 | −1.3844E−01 | 9.5219E−01 | −4.0320E+00 | 1.1246E+01 | −2.1638E+01 | 2.9523E+01 |
| S6 | −2.6598E−02 | 1.3410E−02 | −1.0467E−01 | 4.3326E−01 | −1.0410E+00 | 1.5615E+00 | −1.4977E+00 |
| S7 | −8.2891E−02 | 2.5986E−01 | −1.5880E+00 | 6.1249E+00 | −1.5939E+01 | 2.9075E+01 | −3.8039E+01 |
| S8 | −5.2917E−02 | 8.1776E−02 | −3.6996E−01 | 1.0516E+00 | −2.0000E+00 | 2.6503E+00 | −2.5077E+00 |
| S9 | −4.1967E−02 | 9.4367E−03 | 6.4624E−02 | −1.9174E−01 | 2.9726E−01 | −3.0142E−01 | 2.1193E−01 |
| S10 | −1.8832E−01 | 1.5749E−01 | −1.6126E−01 | 1.5684E−01 | −1.2670E−01 | 8.0509E−02 | 3.9272E−02 |
| S11 | −1.0963E−01 | 9.0738E−02 | −7.8909E−02 | 5.0522E−02 | −23374E−02 | 7.7294E−03 | −1.8304E−03 |
| S12 | 2.3091E−02 | 1.4172E−02 | −3.0993E−02 | 2.2946E−0 | −1.0579E−02 | 3.3378E−03 | −7.4478E−04 |
| S13 | −2.1016E−01 | 1.3096E−01 | −6.8160E−02 | 2.8001E−02 | −8.3132E−03 | 1.7548E−03 | −2.6574E−04 |
| S14 | −7.5561E−02 | 3.3571E−02 | −1.1186E−02 | 2.6604E−03 | −4.2851E−04 | 4.2117E−05 | −1.5116E−06 |
| Surface number | A18 | A20 | A22 | A24 | A26 | A28 | A30 |
| S1 | 2.5151E−01 | −1.0785E−01 | 3.3070E−02 | −7.0568E−03 | 9.9391E−04 | −8.2945E−05 | 3.1027E−06 |
| S2 | 4.6688E−01 | −2.7970E−01 | −3.1170E−02 | 1.1383E−01 | 5.5040E−03 | −5.6640E−04 | 2.5813E−05 |
| S3 | −4.8337E+00 | 2.6245E+00 | −1.0174E+00 | 2.7469E−01 | −4.9077E−02 | 5.2159E−03 | −2.4971E−04 |
| S4 | 7.3196E+00 | −3.9774E+00 | 1.4068E+00 | −2.9387E−01 | 2.7680E−02 | 0.0000E+00 | 0.0000E+00 |
| S5 | −2.8974E+01 | 2.0508E+01 | −1.0369E+01 | 3.6508E+00 | −8.4981E−01 | 1.1751E−01 | −7.3068E−03 |
| S6 | 8.9047E−01 | −2.7489E−01 | −7.5993E−03 | 4.2162E−02 | −1.6257E−02 | 2.7822E−03 | −1.8594E−04 |
| S7 | 3.6106E+01 | −2.4886E+01 | 1.2320E+01 | −4.2664E+00 | 9.8039E−01 | −1.3423E−01 | 8.2837E−03 |
| S8 | 1.7160E+00 | −8.5081E−01 | 3.0261E−01 | −7.5224E−02 | 1.2402E−02 | −1.2178E−03 | 5.3869E−05 |
| S9 | −1.0577E−01 | 3.7723E−02 | −9.5426E−03 | 1.6700E−03 | −1.9197E−04 | 1.3018E−05 | −3.9407E−07 |
| S10 | 1.4445E−02 | −3.9295E−03 | 7.7181E−04 | −1.0578E−04 | 9.5626E−06 | −5.1120E−07 | 1.2225E−08 |
| IS11 | 3.1204E−04 | −3.8310E−05 | 3.3549E−06 | −2.0442E−07 | 8.2355E−09 | −1.9725E−10 | 2.1275E−12 |
| S12 | 1.1926E−04 | −1.3744E−05 | 1.1290E−06 | −6.4462E−08 | 2.4292E−09 | −5.4291E−11 | 5.4474E−13 |
| S13 | 2.9151E−05 | −2.3216E−06 | 1.3302E−07 | −5.3478E−09 | 1.4329E−10 | −2.2989E−12 | 1.6714E−14 |
| S14 | −2.0291E−07 | 3.6887E−08 | −2.9564E−09 | 1.4263E−10 | −4.2530E−12 | 7.2598E−14 | −5.4484E−16 |

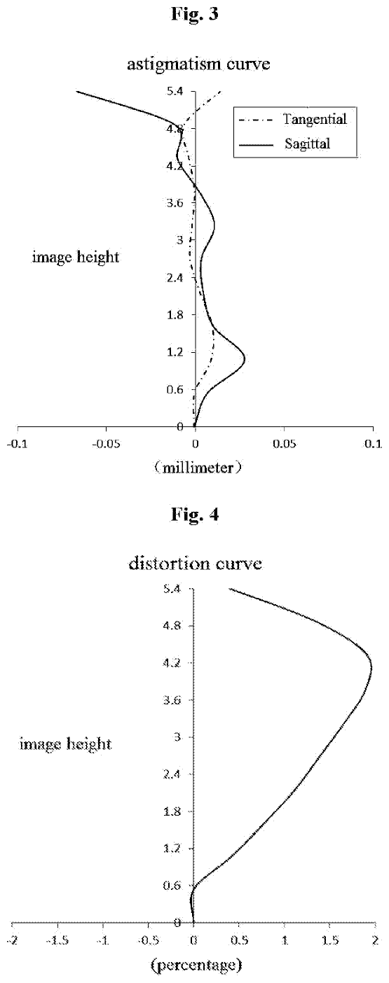

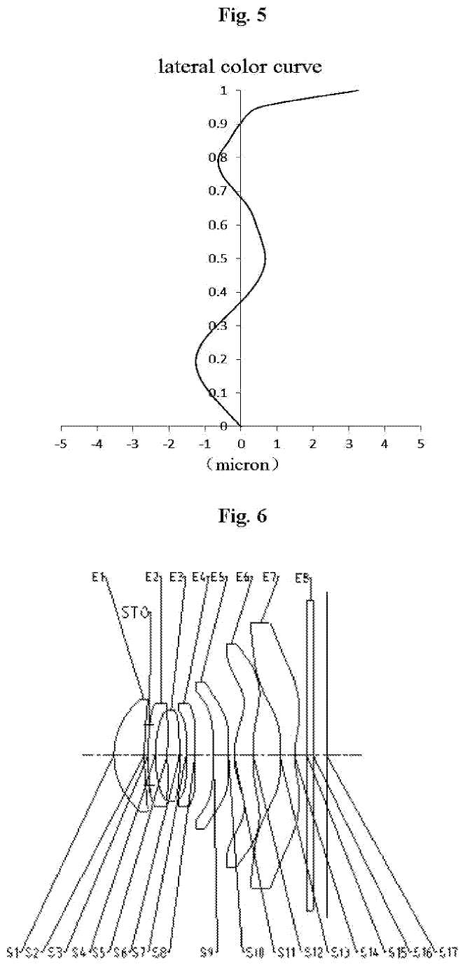

FIG. 2 shows a longitudinal aberration curve of the optical imaging lens group of Example 1 when the object distance is 7000 mm, which represents deviations of a convergence focal point after lights with different wavelengths pass through the optical imaging lens group. FIG. 3 shows an astigmatism curve of the optical imaging lens group of Example 1 when the object distance is 7000 mm, which represents a tangential image surface curvature and a sagittal image surface curvature. FIG. 4 shows a distortion curve of the optical imaging lens group of Example 1 when the object distance is 7000 mm, which represents distortion magnitude values corresponding to different field of views. FIG. 5 shows a lateral color curve of the optical imaging lens group of Example 1 when the object distance is 7000 mm, which represents deviations of different image heights on the imaging surface after the light passes through the optical imaging lens group.

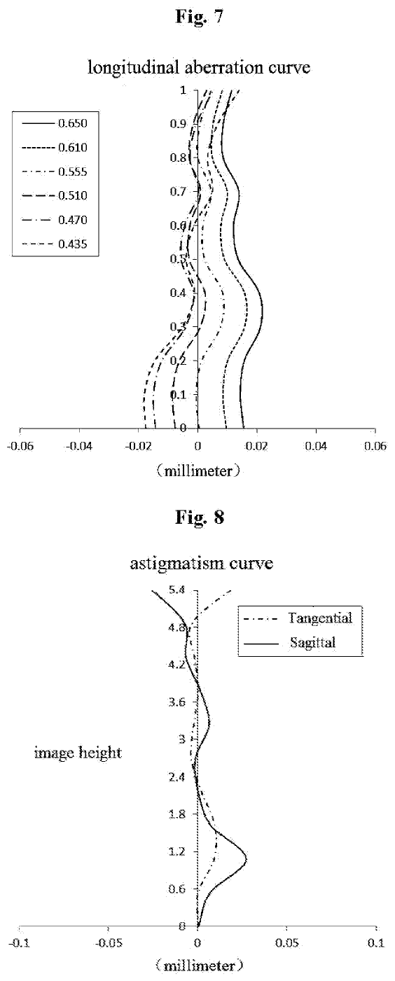

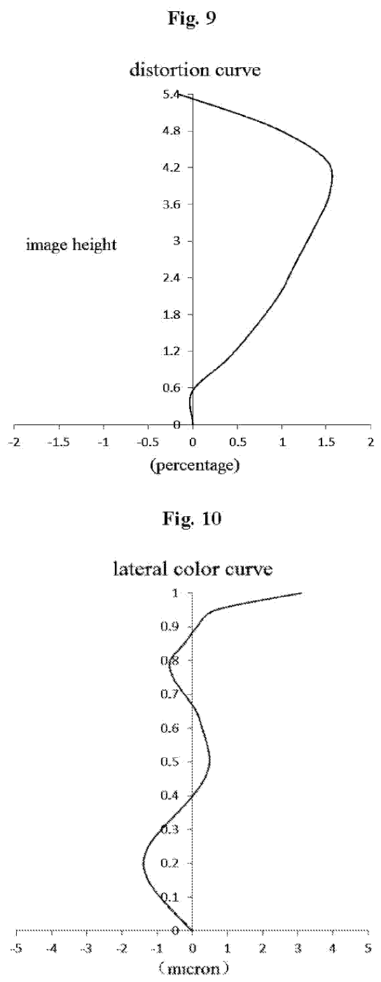

FIG. 7 shows a longitudinal aberration curve of the optical imaging lens group of Example 1 when the object distance is 1000 mm, which represents deviations of a convergence focal point after lights with different wavelengths pass through the optical imaging lens group. FIG. 8 shows an astigmatism curve of the optical imaging lens group of Example 1 when the object distance is 1000 mm, which represents a tangential image surface curvature and a sagittal image surface curvature. FIG. 9 shows a distortion curve of the optical imaging lens group of Example 1 when the object distance is 1000 mm, which represents distortion magnitude values corresponding to different field of views. FIG. 10 shows a lateral color curve of the optical imaging lens group of Example 1 when the object distance is 1000 mm, which represents deviations of different image heights on the imaging surface after the light passes through the optical imaging lens group.

It can be seen from FIGS. 2-5 and FIGS. 7-10 that, the optical imaging lens group given in Example 1 may achieve good imaging quality.

### EXAMPLE 2

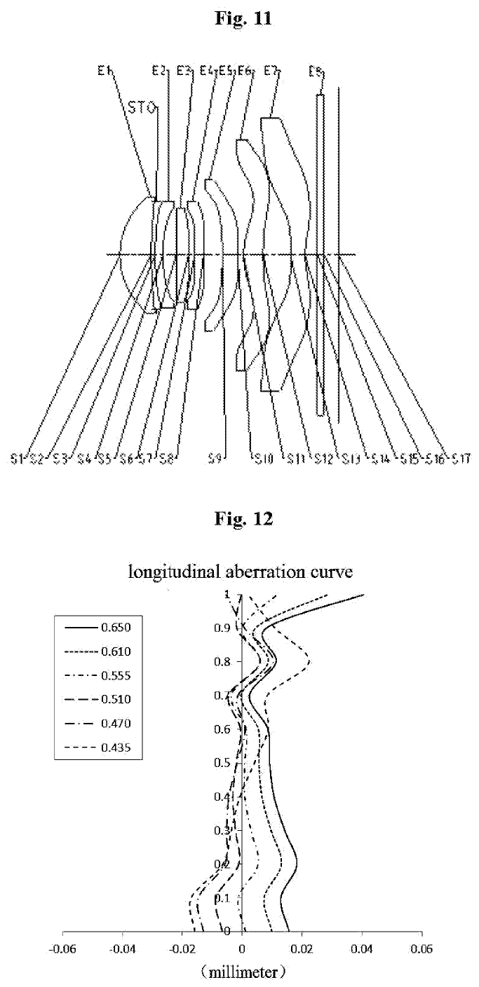

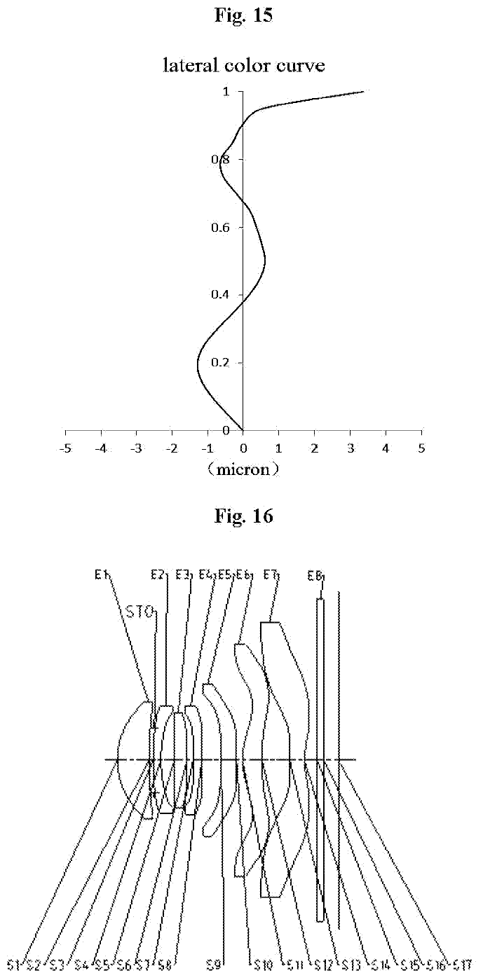

As shown in FIGS. 11-20, an optical imaging lens group of Example 2 of the disclosure is described. In the example and the following examples, for the sake of brevity, some descriptions similar to those of Example 2 will be omitted. FIG. 11 shows a structural schematic diagram of the optical imaging lens group of Example 2 when an object distance is 7000 mm, and FIG. 16 shows a structural schematic diagram of the optical imaging lens group of Example 2 when the object distance is 1000 mm.

As shown in FIG. 11 and FIG. 16, the optical imaging lens group sequentially includes from an object side to an image side: a first lens E1, an iris diaphragm STO, a second lens E2, a third lens E3, a fourth lens E4, a fifth lens E5, a sixth lens E6, a seventh lens E7, a filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a negative refractive power, an object-side surface S9 of the fifth lens is a concave surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The filter E8 has an object-side surface S15 of the filter and an image-side surface S16 of the filter. Light from an object sequentially passes through the surfaces S1 to S16 and is finally imaged on the imaging surface S17.

In the example, a total effective focal length f of the optical imaging lens group is 5.89 mm, when the object distance of the optical imaging lens group is 7000 mm, a maximum field of view (FOV) is 84.6°, TTL is 7.00 mm, and Fno is 1.59; and when the object distance of the optical imaging lens group is 1000 mm, the maximum field of view (FOV) is 84.4°, TTL is 7.03 mm, and Fno is 2.43.

Table 4 shows a basic structural parameter table of the optical imaging lens group of Example 2, wherein the units of curvature radius, thickness/distance and focal length are all millimeters (mm).

TABLE 4

| | | | | Material | | |
|---|---|---|---|---|---|---|
| Surface | Surface | Curvature | | Refractive | Abbe | Conic |
| number | type | radius | Thickness | index | number | coefficient |
| OBJ | Spherical | Infinite | OT | | | |
| S1 | Aspheric | 2.3818 | 1.0088 | 1.55 | 56.1 | −0.9135 |
| S2 | Aspheric | 11.2331 | 0.2148 | | | 16.4489 |
| STO | Spherical | Infinite | −0.1545 | | | |
| S3 | Aspheric | 7.4607 | 0.2480 | 1.67 | 20.4 | −4.5846 |
| S4 | Aspheric | 3.9523 | 0.4428 | | | −0.408 |
| S5 | Aspheric | 25.6519 | 0.4056 | 1.57 | 37.3 | −99.0000 |
| S6 | Aspheric | −58.3494 | 0.2248 | | | 8.0314 |
| S7 | Aspheric | 17.4057 | 0.2883 | 1.67 | 20.4 | −3.1416 |
| S8 | Aspheric | 11.9613 | 0.6091 | | | 16.4899 |
| S9 | Aspheric | −29.5453 | 0.4903 | 1.57 | 37.3 | 0.0000 |
| S10 | Aspheric | 6.1937 | 0.1910 | | | 0.0000 |
| S11 | Aspheric | 1.9895 | 0.6260 | 1.55 | 56.1 | −1.0000 |
| S12 | Aspheric | 11.3762 | 0.8820 | | | 0.0000 |
| S13 | Aspheric | 6.7239 | 0.4650 | 1.54 | 55.7 | −0.2665 |
| S14 | Aspheric | 1.8045 | 0.4162 | | | −9.4107 |
| S15 | Spherical | Infinite | 0.2100 | 1.52 | 64.2 | |
| S16 | Spherical | Infinite | D1 | | | |
| S17 | Spherical | Infinite | | | | |

D1 is shown in Table 5.

TABLE 5

| | | |
|---|---|---|
| OT | 7000 | 1000 |
| D1 | 0.4318 | 0.4616 |

Table 6 shows high-order coefficients that may be used for various aspheric lens surfaces in Example 2, wherein each aspheric surface shape may be defined by formula (1) given in Example 2 describe above.

TABLE 6

| Surface number | A4 | A6 | A8 | A10 | A12 | A14 | A16 |
|---|---|---|---|---|---|---|---|
| S1 | 4.6757E−03 | 2.9861E−02 | −1.1166E−01 | 2.7326E−01 | −4.4898E−01 | 5.1544E−01 | −4.2316E−01 |
| S2 | −1.9379E−02 | 8.4273E−03 | 2.6836E−02 | −2.7301E−02 | −1.0346E−01 | 3.4400E−01 | −5.0627E−01 |
| S3 | −2.5928E−02 | −6.5850E−02 | 5.4789E−01 | −1.8804E+00 | 4.0908E+00 | −6.0857E+00 | 6.3941E+00 |
| S4 | −2.1444E−02 | 7.0315E−02 | −3.9242E−01 | 1.6280E+00 | −4.2622E+00 | 7.3253E+00 | −8.5040E+00 |
| S5 | −7.7881E−04 | −1.3662E−01 | 9.3754E−01 | −3.9683E+00 | 1.1075E+01 | −2.1334E+01 | 2.9154E+01 |
| S6 | −2.7276E−02 | 2.0232E−02 | −1.4930E−01 | 6.2309E−01 | −1.5834E+00 | 2.6388E+00 | −3.0182E+00 |
| S7 | −8.0362E−02 | 2.3001E−01 | −1.4423E+00 | 5.6642E+00 | −1.4945E+01 | 2.7573E+01 | −3.6432E+01 |
| S8 | −5.2032E−02 | 7.0799E−02 | −3.2505E−01 | 9.2398E−01 | −1.7406E+00 | 2.2730E+00 | −2.1125E+00 |
| S9 | −4.3496E−02 | 1.4542E−02 | 5.2342E−02 | −1.6927E−01 | 2.6669E−01 | −2.7105E−01 | 1.9008E−01 |
| S10 | −1.9522E−01 | 1.7034E−01 | −1.8068E−01 | 1.7890E−01 | −1.4504E−01 | 9.1753E−02 | −4.4403E−02 |
| S11 | −1.1432E−01 | 9.7008E−02 | −8.5745E−02 | 5.5578E−02 | −2.5878E−02 | 8.5805E−03 | −2.0336E−03 |
| S12 | 2.3793E−02 | 1.3930E−02 | −3.1849E−02 | 2.3960E−02 | −1.1132E−02 | 3.5222E−03 | −7.8608E−04 |
| S13 | −2.1161E−01 | 1.3246E−01 | −6.8641E−02 | 2.7923E−02 | −8.1927E−03 | 1.7079E−03 | −2.5538E−04 |
| S14 | −7.6142E−02 | 3.3893E−02 | −1.1216E−02 | 2.6387E−03 | −4.2025E−04 | 4.0808E−05 | −1.4189E−06 |
| Surface number | A18 | A20 | A22 | A24 | A26 | A28 | A30 |
| S1 | 2.5114E−01 | −1.0777E−01 | 3.3057E−02 | −7.0549E−03 | 9.9361E−04 | −8.2911E−05 | 3.1009E−06 |
| S2 | 4.5633E−01 | −2.7313E−01 | 1.1100E−01 | −3.0347E−02 | 5.3488E−03 | −5.4937E−04 | 2.4986E−05 |
| S3 | −4.8199E+00 | 2.6164E+00 | −1.0140E+00 | 2.7370E−01 | −4.8887E−02 | 5.1945E−03 | −2.4863E−04 |
| S4 | 6.7212E+00 | −3.5542E+00 | 1.1819E+00 | −2.0153E−01 | −1.9825E−03 | 6.8406E−03 | −8.1994E−04 |
| S5 | −2.8663E+01 | 2.0324E+01 | −1.0294E+01 | 3.6302E+00 | −8.4621E−01 | 1.1716E−01 | −7.2925E−03 |
| S6 | 2.4327E+00 | −1.4007E+00 | 5.7813E−01 | −1.6953E−01 | 3.4217E−02 | −4.3532E−03 | 2.6691E−04 |
| S7 | 3.4884E+01 | −2.4231E+01 | 1.2080E+01 | −4.2094E+00 | 9.7271E−01 | −1.3385E−01 | 8.2974E−03 |
| S8 | 1.4163E+00 | −6.8655E−01 | 2.3821E−01 | −5.7634E−02 | 9.2249E−03 | −8.7682E−04 | 3.7415E−05 |
| S9 | −9.4434E−02 | 3.3506E−02 | −8.4309E−03 | 1.4678E−03 | −1.6787E−04 | 1.1325E−05 | −3.4100E−07 |
| S10 | 1.6193E−02 | −4.3712E−03 | 8.5320E−04 | −1.1637E−04 | 1.0482E−05 | −5.5892E−07 | 1.3342E−08 |
| S11 | 3.4666E−04 | −4.2540E−05 | 3.7228E−06 | −2.2667E−07 | 9.1244E−09 | −2.1837E−10 | 2.3534E−12 |
| S12 | 1.2573E−04 | −1.4464E−05 | 1.1860E−06 | −6.7601E−08 | 2.5438E−09 | −5.6793E−11 | 5.6944E−13 |
| S13 | 2.7660E−05 | −2.1751E−06 | 1.2308E−07 | −4.8887E−09 | 1.2946E−10 | −2.0539E−12 | 1.4776E−14 |
| S14 | −2.0126E−07 | 3.5918E−08 | −2.8606E−09 | 1.3745E−10 | −4.0848E−12 | 6.9511E−14 | −5.2005E−16 |

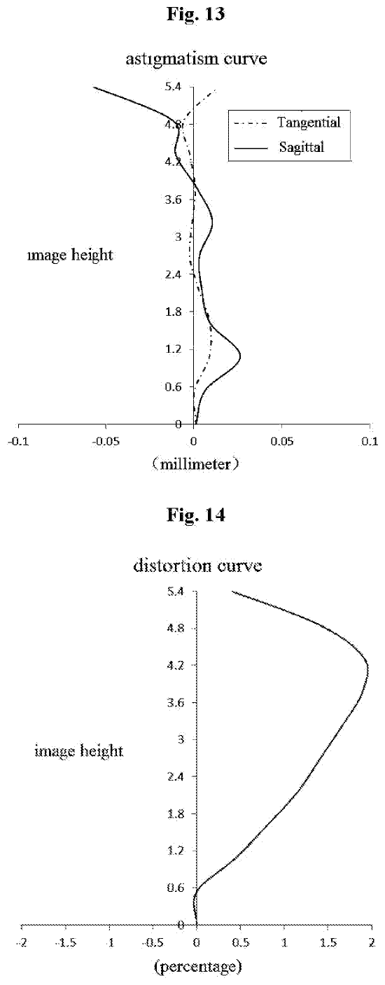

FIG. 12 shows a longitudinal aberration curve of the optical imaging lens group of Example 2 when the object distance is 7000 mm, which represents deviations of a convergence focal point after lights with different wavelengths pass through the optical imaging lens group. FIG. 13 shows an astigmatism curve of the optical imaging lens group of Example 2 when the object distance is 7000 mm, which represents a tangential image surface curvature and a sagittal image surface curvature. FIG. 14 shows a distortion curve of the optical imaging lens group of Example 2 when the object distance is 7000 mm, which represents distortion magnitude values corresponding to different field of views. FIG. 15 shows a lateral color curve of the optical imaging lens group of Example 2 when the object distance is 7000 mm, which represents deviations of different image heights on the imaging surface after the light passes through the optical imaging lens group.

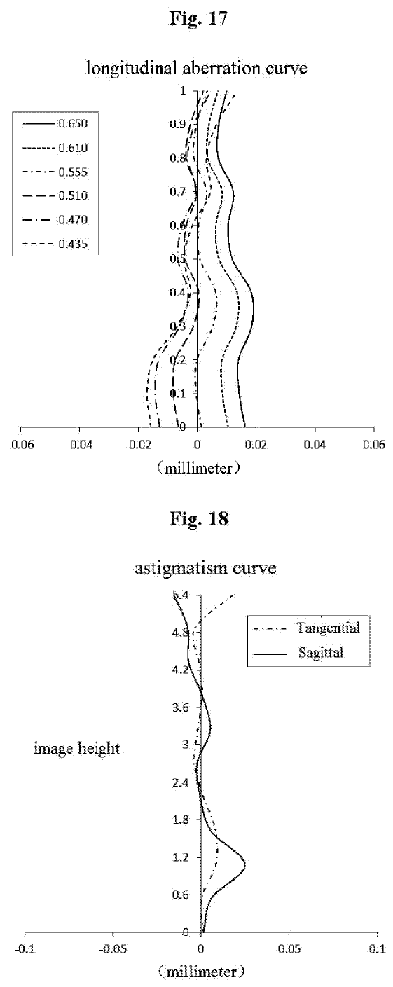

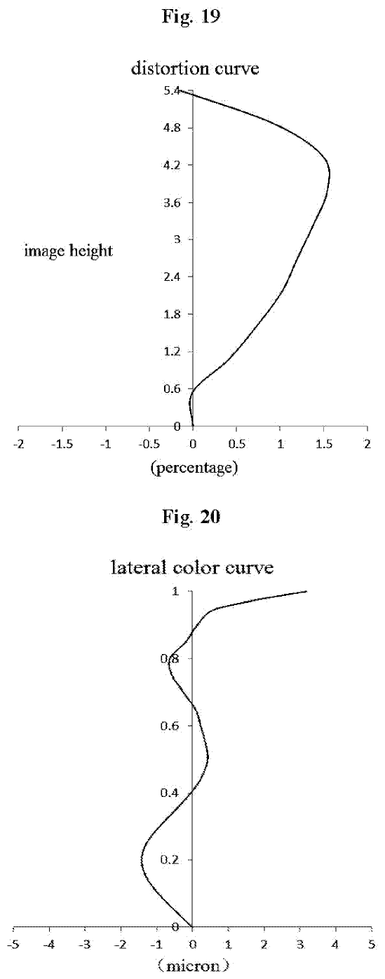

FIG. 17 shows a longitudinal aberration curve of the optical imaging lens group of Example 2 when the object distance is 1000 mm, which represents deviations of a convergence focal point after lights with different wavelengths pass through the optical imaging lens group. FIG. 18 shows an astigmatism curve of the optical imaging lens group of Example 2 when the object distance is 1000 mm, which represents a tangential image surface curvature and a sagittal image surface curvature. FIG. 19 shows a distortion curve of the optical imaging lens group of Example 2 when the object distance is 1000 mm, which represents distortion magnitude values corresponding to different field of views. FIG. 20 shows a lateral color curve of the optical imaging lens group of Example 2 when the object distance is 1000 mm, which represents deviations of different image heights on the imaging surface after the light passes through the optical imaging lens group.

It can be seen from FIGS. 12-15 and FIGS. 17-20 that, the optical imaging lens group given in Example 2 may achieve good imaging quality.

### EXAMPLE 3

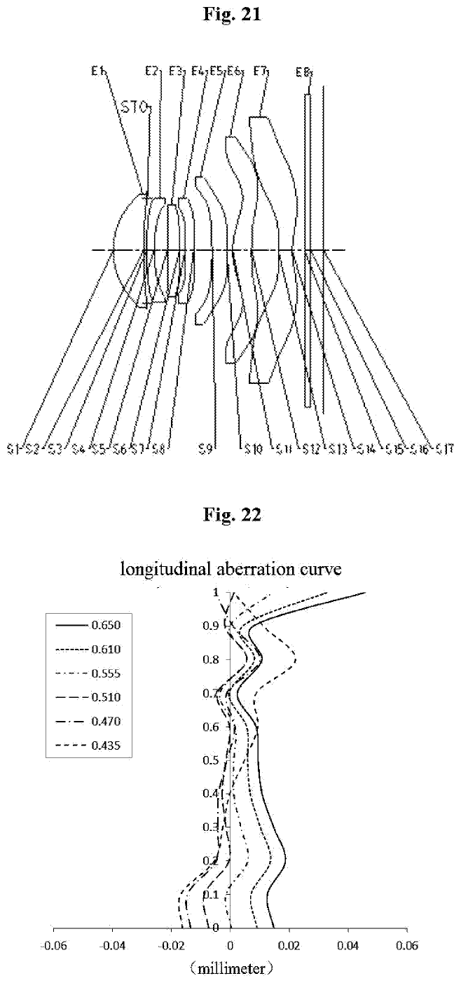

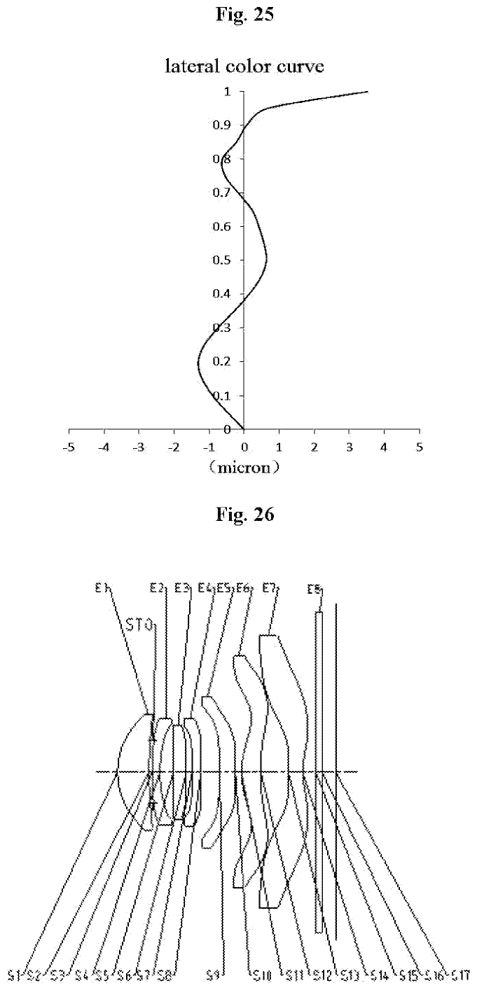

As shown in FIGS. 21-30, an optical imaging lens group of Example 3 of the disclosure is described. In the example and the following examples, for the sake of brevity, some descriptions similar to those of Example 3 will be omitted. FIG. 21 shows a structural schematic diagram of the optical imaging lens group of Example 3 when an object distance is 7000 mm, and FIG. 26 shows a structural schematic diagram of the optical imaging lens group of Example 3 when the object distance is 1000 mm.

As shown in FIG. 21 and FIG. 26, the optical imaging lens group sequentially includes from an object side to an image side: a first lens E1, an iris diaphragm STO, a second lens E2, a third lens E3, a fourth lens E4, a fifth lens E5, a sixth lens E6, a seventh lens E7, a filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a negative refractive power, an object-side surface S9 of the fifth lens is a concave surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The filter E8 has an object-side surface S15 of the filter and an image-side surface S16 of the filter. Light from an object sequentially passes through the surfaces S1 to S16 and is finally imaged on the imaging surface S17.

In the example, a total effective focal length f of the optical imaging lens group is 5.89 mm, when the object distance of the optical imaging lens group is 7000 mm, a maximum field of view (FOV) is 84.6°, TTL is 7.00 mm, and Fno is 1.59; and when the object distance of the optical imaging lens group is 1000 mm, the maximum field of view (FOV) is 84.4°, the TTL is 7.03 mm, and the Fno is 2.43.

Table 7 shows a basic structural parameter table of the optical imaging lens group of Example 3, wherein the units of curvature radius, thickness/distance and focal length are all millimeters (mm).

TABLE 7

| | | | | Material | | |
|---|---|---|---|---|---|---|
| Surface | Surface | Curvature | | Refractive | Abbe | Conic |
| number | type | radius | Thickness | index | number | coefficient |
| OBJ | Spherical | Infinite | OT | | | |
| S1 | Aspheric | 2.3821 | 1.0090 | 1.55 | 56.1 | −0.9129 |
| S2 | Aspheric | 11.2479 | 0.2146 | | | 16.4591 |
| STO | Spherical | Infinite | −0.1557 | | | |
| S3 | Aspheric | 7.3707 | 0.2480 | 1.67 | 20.4 | −4.7411 |
| S4 | Aspheric | 3.9203 | 0.4423 | | | −0.4284 |
| S5 | Aspheric | 25.5038 | 0.4059 | 1.57 | 37.3 | −99.0000 |
| S6 | Aspheric | −58.9200 | 0.2253 | | | 7.9585 |
| S7 | Aspheric | 17.3861 | 0.2880 | 1.67 | 20.4 | −3.0467 |
| S8 | Aspheric | 11.8982 | 0.6079 | | | 16.4963 |
| S9 | Aspheric | −31.5387 | 0.4925 | 1.57 | 37.3 | 0.0000 |
| S10 | Aspheric | 6.0580 | 0.1925 | | | 0.0000 |
| S11 | Aspheric | 1.9762 | 0.6250 | 1.55 | 56.1 | −1.0000 |
| S12 | Aspheric | 11.3536 | 0.8881 | | | 0.0000 |
| S13 | Aspheric | 6.8617 | 0.4592 | 1.54 | 55.7 | −0.2844 |
| S14 | Aspheric | 1.8099 | 0.4161 | | | −9.5160 |
| S15 | Spherical | Infinite | 0.2100 | 1.52 | 64.2 | |
| S16 | Spherical | Infinite | D1 | | | |
| S17 | Spherical | Infinite | | | | |

D1 is shown in Table 8,

TABLE 8

| | | |
|---|---|---|
| OT | 7000 | 1000 |
| D1 | 0.4314 | 0.4617 |

Table 9 shows high-order coefficients that may be used for various aspheric lens surfaces in Example 3, wherein each aspheric surface shape may be defined by formula (1) given in Example 3 describe above.

TABLE 9

| Surface number | A4 | A6 | A8 | A10 | A12 | A14 | A16 |
|---|---|---|---|---|---|---|---|
| S1 | 4.7280E−03 | 2.9506E−02 | −1.1050E−01 | 2.7107E−01 | −4.4617E−01 | 5.1276E−01 | −4.2115E−01 |
| S2 | −1.9502E−02 | 8.6866E−03 | 2.6801E−02 | −2.8175E−02 | −1.0071E−01 | 3.3888E−01 | −4.9980E−01 |
| S3 | −2.6054E−02 | −6.5516E−02 | 5.4609E−01 | −1.8746E+00 | 4.0777E+00 | −6.0646E+−00 | 6.3698E+−00 |
| S4 | −2.1333E−02 | 6.8747E−02 | −3.8353E−01 | 1.5915E+00 | −4.1635E+00 | 7.1455E+00 | −8.2764E+00 |
| S5 | −9.7173E−04 | −1.3361E−01 | 9.2223E−01 | −3.9218E+00 | 1.0984E+01 | −2.1220E+01 | 2.9071E+01 |
| S6 | −2.7138E−02 | 1.9037E−02 | −1.4530E−01 | 6.2653E−01 | −1.6428E+00 | 2.8307E+00 | −3.3646E+00 |
| S7 | −8.0018E−02 | 2.2312E−01 | −1.4018E+00 | 5.5264E+00 | −1.4650E+01 | 2.7162E+01 | −3.6067E+01 |
| S8 | −5.1509E−02 | 6.2653E−02 | −2.8503E−01 | 8.0888E−01 | −1.5234E+00 | 1.9891E+00 | −1.8473E+00 |
| S9 | −4.5836E−02 | 2.1970E−02 | 3.3604E−02 | −1.3552E−01 | 2.2409E−01 | −2.3288E−01 | 1.6548E−01 |
| S10 | −1.9850E−01 | 1.7534E−01 | −1.8755E−01 | 1.8585E−01 | −1.4989E−01 | 9.4039E−02 | −4.5097E−02 |
| S11 | −1.1520E−01 | 9.7882E−02 | −8.6928E−02 | 5.6533E−02 | −2.6356E−02 | 8.7403E−03 | −2.0711E−03 |
| S12 | 2.4872E−02 | 1.3463E−02 | −3.2222E−02 | 2.4463E−02 | −1.1397E−02 | 3.6061E−03 | −8.0389E−04 |
| S13 | −2.1269E−01 | 1.3452E−01 | −7.0101E−02 | 2.8519E−02 | 8.3448E−03 | 1.7329E−03 | −2.5799E−04 |
| S14 | −7.6722E−02 | 3.4483E−02 | −1.1483E−02 | 2.7101E−03 | −4.3290E−04 | 4.2391E−05 | −1.5681E−06 |
| Surface number | A18 | A20 | A22 | A24 | A26 | A28 | A30 |
| S1 | 2.4995E−01 | −1.0722E−01 | 3.2868E−02 | −7.0085E−03 | 9.8603E−04 | −8.2175E−05 | 3.0689E−06 |
| S2 | 4.5066E−01 | −2.6965E−01 | 1.0952E−01 | −2.9917E−02 | 5.2685E−03 | −5.4059E−04 | 2.4561E−05 |
| S3 | −4.7997E+00 | 2.6044E+00 | −1.0090E+00 | 2.7224E−01 | −4.8608E−02 | 5.1630E−03 | −2.4704E−04 |
| S4 | 6.5166E+00 | −3.4227E+00 | 1.1219E+00 | −1.8246E−01 | −5.9765E−03 | 7.3371E−03 | −8.4764E−04 |
| S5 | −2.8643E+01 | 2.0350E+01 | −1.0326E+01 | 3.6472E+00 | −8.5145E−01 | 1.1804E−01 | −7.3566E−03 |
| S6 | 2.8395E+00 | −1.7277E+00 | 7.6014E−01 | −2.3871E−01 | 5.1376E−02 | −6.8588E−03 | 4.3036E−04 |
| S7 | 3.4699E+01 | −2.4211E+01 | 1.2121E+01 | −4.2402E+00 | 9.8333E−01 | −1.3575E−01 | 8.4401E−03 |
| S8 | 1.2368E+00 | −5.9819E−01 | 2.0690E−01 | −4.9844E−02 | 7.9335E−03 | −7.4864E−04 | 3.1650E−05 |
| S9 | −8.2933E−02 | 2.9607E−02 | −7.4835E−03 | 1.3070E−03 | −1.4979E−04 | 1.0117E−05 | 3.0465E−07 |
| S10 | 1.6307E−02 | −4.3699E−03 | 8.4787E−04 | −1.1510E−04 | 1.0327E−05 | −5.4894E−07 | 1.3070E−08 |
| S11 | 3.5300E−04 | −4.3315E−05 | 3.7911E−06 | −2.3088E−07 | 9.2974E−09 | −2.2261E−10 | 2.4004E−12 |
| S12 | 1.2837E−04 | −1.4739E−05 | 1.2062E−06 | −6.8613E−08 | 2.5769E−09 | −5.7426E−11I | 5.7479E−13 |
| S13 | 2.7820E−05 | −2.1781E−06 | 1.2273E−07 | −4.8543E−09 | 1.2804E−10 | −2.0237E−12 | 1.4507E−14 |
| S14 | −1.8959E−07 | 3.5098E−08 | −2.8107E−09 | 1.3512E−10 | −4.0118E−12 | 6.8173E−14 | −5.0933E−16 |

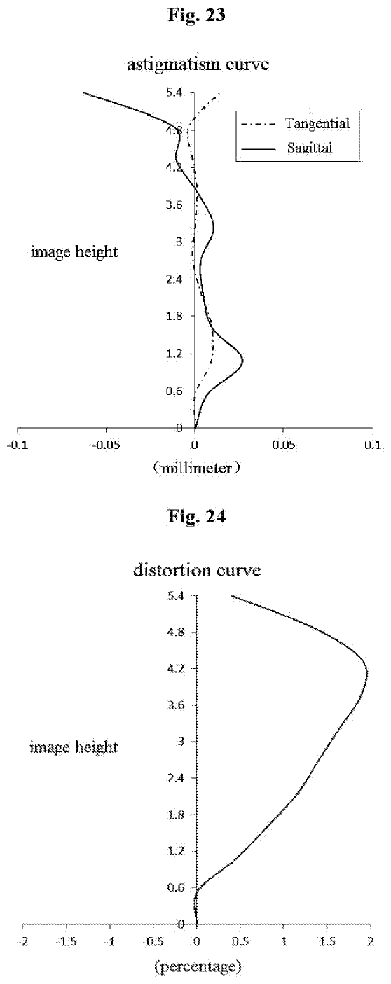

FIG. 22 shows a longitudinal aberration curve of the optical imaging lens group of Example 3 when the object distance is 7000 mm, which represents deviations of a convergence focal point after lights with different wavelengths pass through the optical imaging lens group. FIG. 23 shows an astigmatism curve of the optical imaging lens group of Example 3 when the object distance is 7000 mm, which represents a tangential image surface curvature and a sagittal image surface curvature. FIG. 24 shows a distortion curve of the optical imaging lens group of Example 3 when the object distance is 7000 mm, which represents distortion magnitude values corresponding to different field of views. FIG. 25 shows a lateral color curve of the optical imaging lens group of Example 3 when the object distance is 7000 mm, which represents deviations of different image heights on the imaging surface after the light passes through the optical imaging lens group.

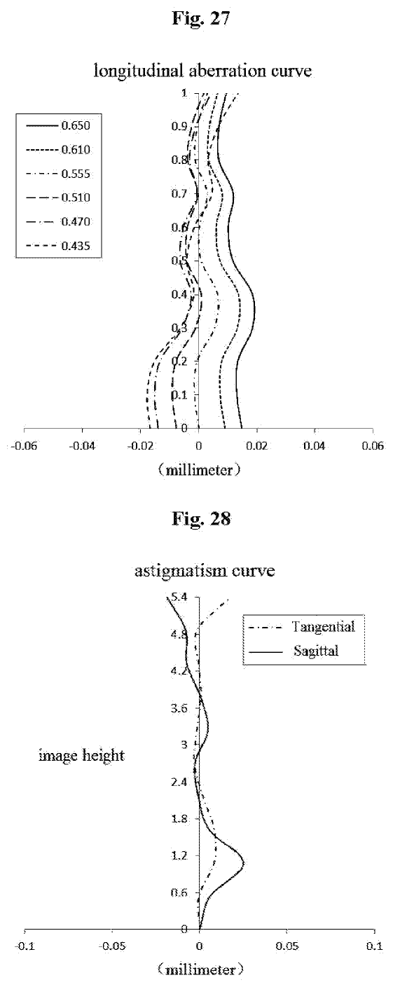

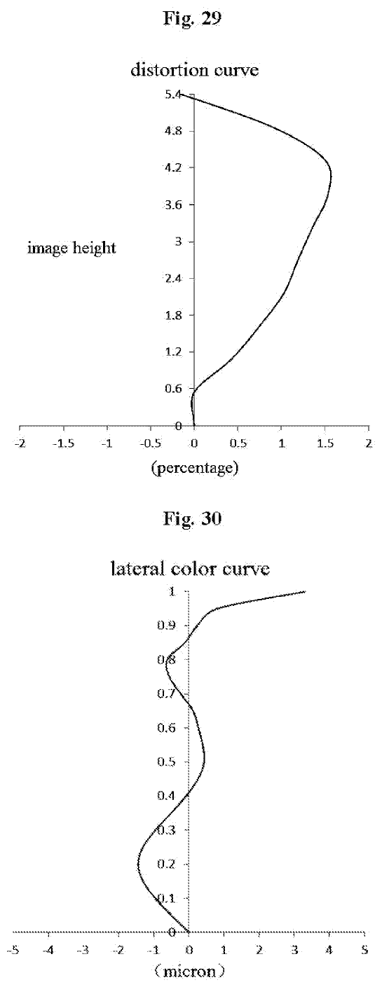

FIG. 27 shows a longitudinal aberration curve of the optical imaging lens group of Example 3 when the object distance is 1000 mm, which represents deviations of a convergence focal point after lights with different wavelengths pass through the optical imaging lens group. FIG. 28 shows an astigmatism curve of the optical imaging lens group of Example 3 when the object distance is 1000 mm, which represents a tangential image surface curvature and a sagittal image surface curvature. FIG. 29 shows a distortion curve of the optical imaging lens group of Example 3 when the object distance is 1000 mm, which represents distortion magnitude values corresponding to different field of views. FIG. 30 shows a lateral color curve of the optical imaging lens group of Example 3 when the object distance is 1000 mm, which represents deviations of different image heights on the imaging surface after the light passes through the optical imaging lens group.

It can be seen from FIGS. 22-25 and FIGS. 27-30 that, the optical imaging lens group given in Example 3 may achieve good imaging quality.

### EXAMPLE 4

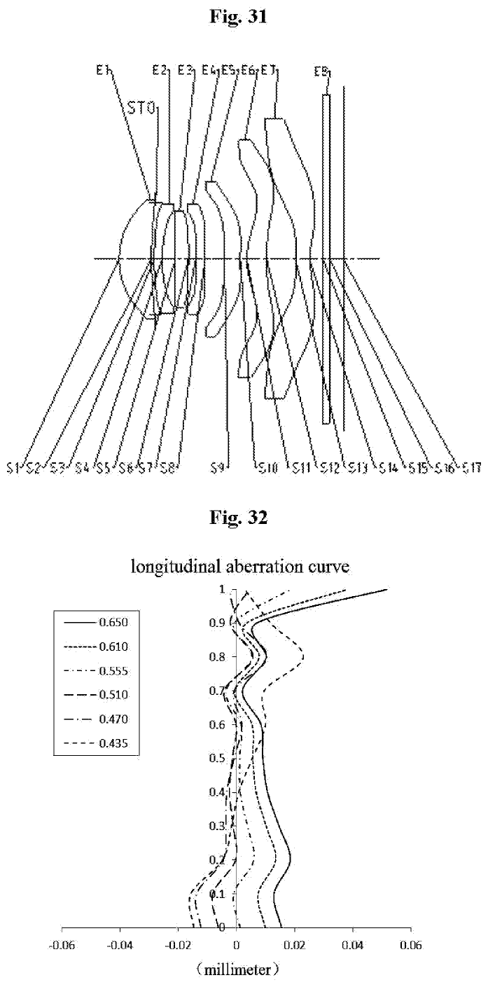

As shown in FIGS. 31-40, an optical imaging lens group of Example 4 of the disclosure is described. In the example and the following examples, for the sake of brevity, some descriptions similar to those of Example 4 will be omitted. FIG. 31 shows a structural schematic diagram of the optical imaging lens group of Example 4 when an object distance is 7000 mm, and FIG. 36 shows a structural schematic diagram of the optical imaging lens group of Example 4 when the object distance is 1000 mm.

As shown in FIG. 31 and FIG. 36, the optical imaging lens group sequentially includes from an object side to an image side: a first lens E1, an iris diaphragm STO, a second lens E2, a third lens E3, a fourth lens E4, a fifth lens E5, a sixth lens E6, a seventh lens E7, a filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a negative refractive power, an object-side surface S9 of the fifth lens is a concave surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The filter E8 has an object-side surface S15 of the filter and an image-side surface S16 of the filter. Light from an object sequentially passes through the surfaces S1 to S16 and is finally imaged on the imaging surface S17.

In the example, a total effective focal length f of the optical imaging lens group is 5.89 mm, when the object distance of the optical imaging lens group is 7000 mm, a maximum field of view (FOV) is 84.6°, TTL is 7.00 mm, and Fno is 1.59; and when the object distance of the optical imaging lens group is 1000 mm, the maximum field of view (FOV) is 84.4°, the TTL is 7.03 mm, and the Fno is 2.43.

Table 10 shows a basic structural parameter table of the optical imaging lens group of Example 4, wherein the units of curvature radius, thickness/distance and focal length are all millimeters (mm).

TABLE 10

| | | | | Material | | |
|---|---|---|---|---|---|---|
| Surface | Surface | Curvature | | Refractive | Abbe | Conic |
| number | type | radius | Thickness | index | number | coefficient |
| OBJ | Spherical | Infinite | OT | | | 0.0000 |
| S1 | Aspheric | 2.3831 | 1.0095 | 1.55 | 56.1 | −0.9110 |
| S2 | Aspheric | 11.2815 | 0.2142 | | | 16.4458 |
| STO | Spherical | Infinite | −0.1580 | | | |
| S3 | Aspheric | 7.2250 | 0.2480 | 1.67 | 20.4 | −4.9979 |
| S4 | Aspheric | 3.8716 | 0.4438 | | | −0.4532 |
| S5 | Aspheric | 25.5140 | 0.4079 | 1.57 | 37.3 | −99.0000 |
| S6 | Aspheric | −57.5820 | 0.2272 | | | 7.9123 |
| S7 | Aspheric | 17.2356 | 0.2890 | 1.67 | 20.4 | −2.7955 |
| S8 | Aspheric | 11.6231 | 0.6044 | | | 16.6237 |
| s9 | Aspheric | −36.7655 | 0.4983 | 1.57 | 37.3 | 0.0000 |
| S10 | Aspheric | 5.8756 | 0.1966 | | | 0.0000 |
| S11 | Aspheric | 1.9614 | 0.6256 | 1.55 | 56.1 | −1.0000 |
| S12 | Aspheric | 11.4596 | 0.8983 | | | 0.0000 |
| S13 | Aspheric | 7.1476 | 0.4435 | 1.54 | 55.7 | −0.3208 |
| S14 | Aspheric | 1.8204 | 0.4141 | | | −9.7253 |
| S15 | Spherical | Infinite | 0.2100 | 1.52 | 64.2 | 0.0000 |
| S16 | Spherical | Infinite | D1 | | | 0.0000 |
| S17 | Spherical | Infinite | | | | 0.0000 |

D1 is shown in Table 11,

TABLE 11

| | | |
|---|---|---|
| OT | 7000 | 1000 |
| D1 | 0.4277 | 0.4578 |

Table 12 shows high-order coefficients that may be used for various aspheric lens surfaces in Example 4, wherein each aspheric surface shape may be defined by formula (1) given in Example 4 describe above.

TABLE 12

| Surface number | A4 | A6 | A8 | A10 | A12 | A14 | A16 |
|---|---|---|---|---|---|---|---|
| S1 | 4.7746E−03 | 2.9096E−02 | −1.0905E−01 | 2.6834E−01 | −4.4291E−01 | 5.1011E−01 | −4.1960E−01 |
| S2 | −1.9779E−02 | 9.3563E−03 | 2.6447E−02 | −2.9511E−02 | 9.5924E−02 | 3.2987E−01 | −4.8848E−01 |
| S3 | −2.6301E−02 | −6.5113E−02 | 5.4340E−01 | −1.8642E+00 | 4.0522E+00 | −6.0218E+00 | 6.3196E+00 |
| S4 | −2.1315E−02 | 6.6458E−02 | −3.6604E−01 | 1.5111E+00 | −3.9382E+00 | 6.7303E+00 | −7.7481E+00 |
| S5 | −1.1373E−03 | −1.2968E−01 | 9.0144E−01 | −3.8570E+00 | 1.0860E+01 | −2.1078E+01 | 2.8997E+−01 |
| S6 | −2.7990E−02 | 2.2944E−02 | −1.6793E−01 | 7.3145E−01 | −1.9756E+00 | 3.5500E+00 | −4.4450E+00 |
| S7 | −8.1049E−02 | 2.1730E−01 | −1.3636E+00 | 5.3920E+00 | −1.4347E+01 | 2.6708E+01 | −3.5609E+01 |
| S8 | −5.3486E−02 | 6.5654E−02 | −2.9296E−01 | 8.2736E−01 | −1.5553E+00 | 2.0292E+00 | −1.8847E+00 |
| S9 | −4.9828E−02 | 3.0643E−02 | 1.7666E−02 | −1.1478E−01 | 2.0523E−01 | −2.2053E−01 | 1.5944E−01 |
| S10 | −2.0431E−01 | 1.8670E−01 | −2.0446E−01 | 2.0063E−01 | −1.5612E−01 | 9.3498E−02 | −4.2863E−02 |
| S11 | −1.1635E−01 | 1.0190E−01 | −9.3454E−02 | 6.1789E−02 | −2.8898E−02 | 9.5514E−03 | −2.2506E−03 |
| S12 | 2.7203E−02 | 1.3953E−02 | −3.4952E−02 | 2.6697E−02 | −1.2367E−02 | 3.8739E−03 | −8.5395E−04 |
| S13 | −2.1425E−01 | 1.3794E−01 | −7.1953E−02 | 2.8849E−02 | −8.2698E−03 | 1.6802E−03 | −2.4477E−04 |
| S14 | −7.8303E−02 | 3.6078E−02 | −1.2187E−02 | 2.8864E−03 | −4.6141E−04 | 4.5620E−05 | −1.8439E−06 |
| Surface number | A18 | A20 | A22 | A24 | A26 | A28 | A30 |
| S1 | 2.4928E−01 | −1.0700E−01 | 3.2810E−02 | −6.9974E−03 | 9.8450E−04 | −8.2044E−05 | 3.0638E−06 |
| S2 | 4.4078E−01 | −2.6363E−01 | 1.0697E−01 | −2.9184E−02 | 5.1319E−03 | −5.2577E−04 | 2.3849E−05 |
| S3 | −4.7580E+00 | 2.5797E+00 | −9.9855E−01 | 2.6922E−01 | −4.8032E−02 | 5.0983E−03 | −2.4379E−04 |
| S4 | 6.0397E+00 | −3.1144E+00 | 9.7988E−01 | −1.3696E−01 | −1.5617E−02 | 8.5504E−03 | −9.1624E−04 |
| S5 | −2.8678E+01 | 2.0445E+01 | −1.0406E+01 | 3.6861E+00 | −8.6271E−01 | 1.1988E−01 | −7.4587E−03 |
| S6 | 3.9860E+00 | −2.5921E+00 | 1.2201E+00 | −4.0742E−01 | 9.1960E−02 | −1.2619E−02 | 7.9584E−04 |
| S7 | 3.4399E+01 | −2.4097E+01 | 1.2110E+01 | −4.2517E+00 | 9.8937E−01 | −1.3702E−01 | 8.5444E−03 |
| S8 | 1.2627E+00 | −6.1141E−01 | 2.1178E−01 | −5.1110E−02 | 8.1509E−03 | −7.7077E−04 | 3.2657E−05 |
| S9 | −8.0647E−02 | 2.8921E−02 | −7.3209E−03 | 1.2779E−03 | −1.4616E−04 | 9.8417E−06 | −2.9525E−07 |
| S10 | 1.4937E−02 | −3.8957E−03 | 7.4212E−04 | −9.9560E−05 | 8.8689E−06 | −4.6914E−07 | 1.1149E−08 |
| S11 | 3.8128E−04 | −4.6518E−05 | 4.0504E−06 | −2.4554E−07 | 9.8484E−09 | −2.3498E−10 | 2.5260E−12 |
| S12 | 1.3486E−04 | −1.5325E−05 | 1.2422E−06 | −7.0046E−08 | 2.6100E−09 | −5.7745E−11 | 5.7423E−13 |
| S13 | 2.5841E−05 | −1.9820E−06 | 1.0948E−07 | 4.2477E−09 | 1.0999E−10 | −1.7083E−12 | 1.2047E−14 |
| S14 | −1.7003E−07 | 3.3836E−08 | −2.7377E−09 | 1.3179E−10 | −3.9083E−12 | 6.6281E−14 | −4.9420E−16 |

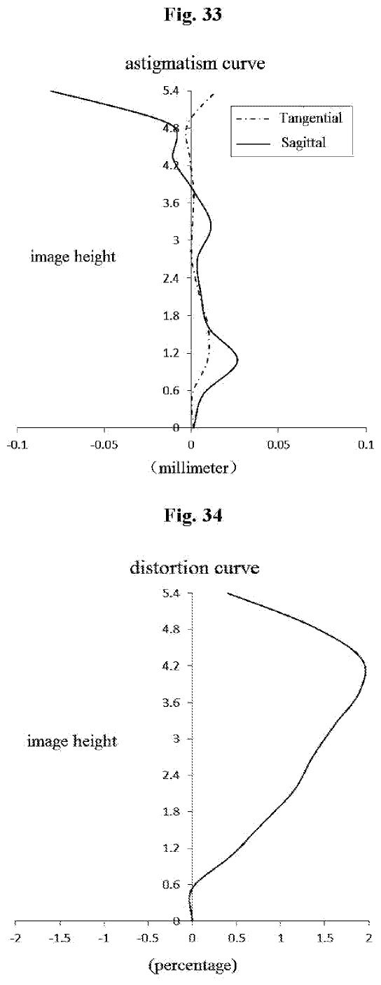

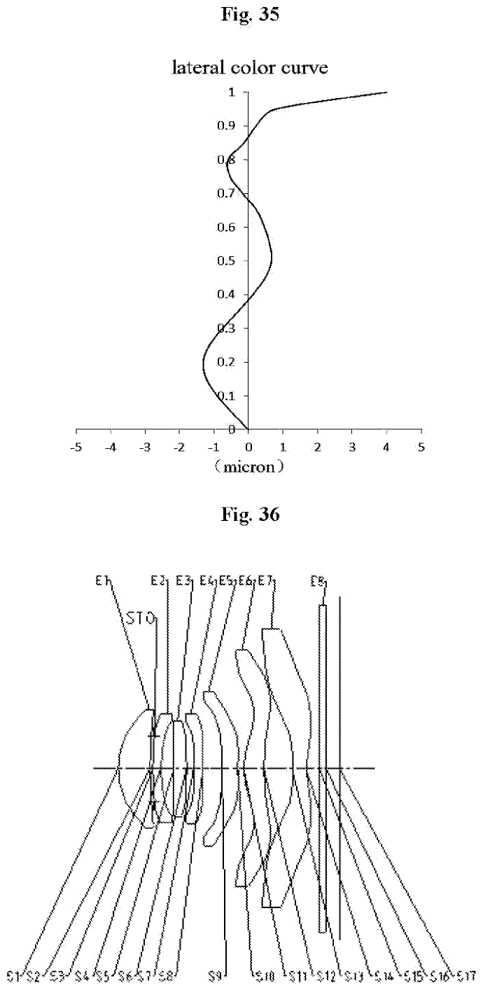

FIG. 32 shows a longitudinal aberration curve of the optical imaging lens group of Example 4 when the object distance is 7000 mm, which represents deviations of a convergence focal point after lights with different wavelengths pass through the optical imaging lens group. FIG. 33 shows an astigmatism curve of the optical imaging lens group of Example 4 when the object distance is 7000 mm, which represents a tangential image surface curvature and a sagittal image surface curvature. FIG. 34 shows a distortion curve of the optical imaging lens group of Example 4 when the object distance is 7000 mm, which represents distortion magnitude values corresponding to different field of views. FIG. 35 shows a lateral color curve of the optical imaging lens group of Example 4 when the object distance is 7000 mm, which represents deviations of different image heights on the imaging surface after the light passes through the optical imaging lens group.

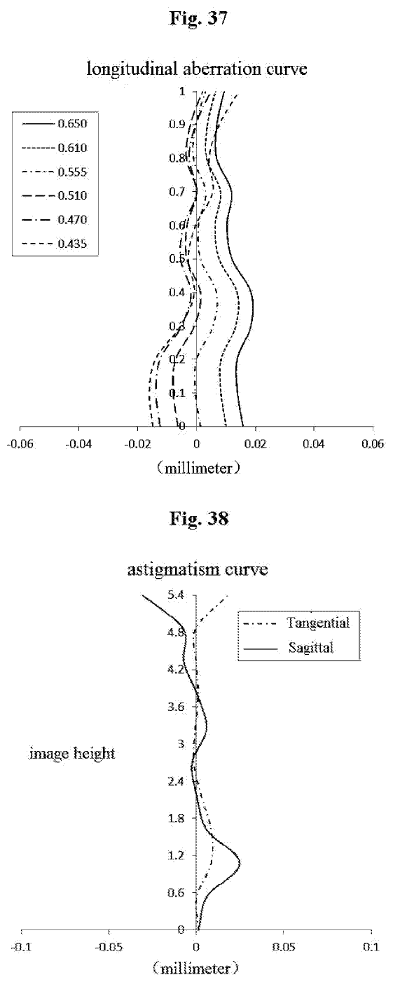

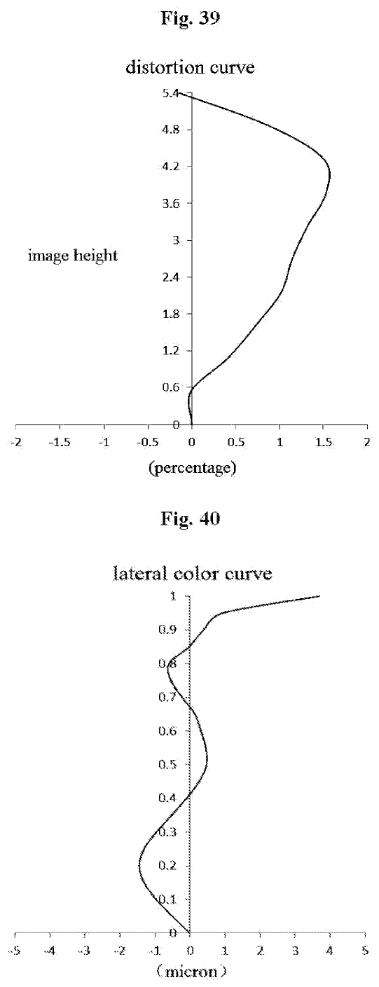

FIG. 37 shows a longitudinal aberration curve of the optical imaging lens group of Example 4 when the object distance is 1000 mm, which represents deviations of a convergence focal point after lights with different wavelengths pass through the optical imaging lens group. FIG. 38 shows an astigmatism curve of the optical imaging lens group of Example 4 when the object distance is 1000 mm, which represents a tangential image surface curvature and a sagittal image surface curvature. FIG. 39 shows a distortion curve of the optical imaging lens group of Example 4 when the object distance is 1000 mm, which represents distortion magnitude values corresponding to different field of views. FIG. 40 shows a lateral color curve of the optical imaging lens group of Example 4 when the object distance is 1000 mm, which represents deviations of different image heights on the imaging surface after the light passes through the optical imaging lens group.

It can be seen from FIGS. 32-35 and FIGS. 37-40 that, the optical imaging lens group given in Example 3 may achieve good imaging quality.

### EXAMPLE 5

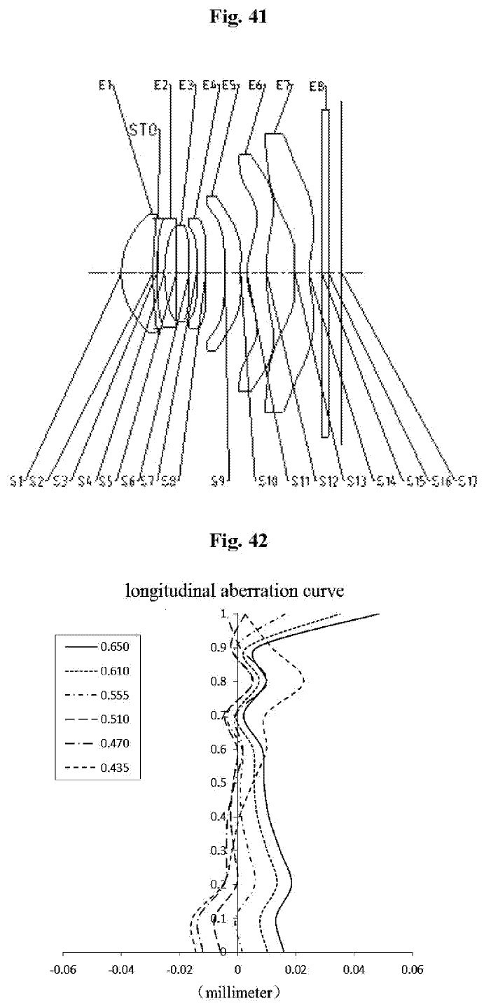

As shown in FIGS. 41-50, an optical imaging lens group of Example 5 of the disclosure is described. In the example and the following examples, for the sake of brevity, some descriptions similar to those of Example 5 will be omitted. FIG. 41 shows a structural schematic diagram of the optical imaging lens group of Example 5 when an object distance is 7000 mm, and FIG. 46 shows a structural schematic diagram of the optical imaging lens group of Example 5 when the object distance is 1000 mm.

As shown in FIG. 41 and FIG. 46, the optical imaging lens group sequentially includes from an object side to an image side: a first lens E1, an iris diaphragm STO, a second lens E2, a third lens E3, a fourth lens E4, a fifth lens E5, a sixth lens E6, a seventh lens E7, a filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a negative refractive power, an object-side surface S9 of the fifth lens is a concave surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The filter E8 has an object-side surface S15 of the filter and an image-side surface S16 of the filter. Light from an object sequentially passes through the surfaces S1 to S16 and is finally imaged on the imaging surface S17.

In the example, a total effective focal length f of the optical imaging lens group is 5.89 mm, when the object distance of the optical imaging lens group is 7000 mm, a maximum field of view (FOV) is 84.9°, TTL is 7.00 mm, and Fno is 1.59; and when the object distance of the optical imaging lens group is 1000 mm, the maximum field of view (FOV) is 84.4°, the TTL is 7.03 mm, and the Fno is 2.43.

Table 13 shows a basic structural parameter table of the optical imaging lens group of Example 5, wherein the units of curvature radius, thickness/distance and focal length are all millimeters (mm).

TABLE 13

| | | | | Material | | |
|---|---|---|---|---|---|---|
| Surface | Surface | Curvature | | Refractive | Abbe | Conic |
| number | type | radius | index | Thickness | number | coefficient |
| OBJ | Spherical | Infinite | OT | | | |
| S1 | Aspheric | 2.3832 | 1.0101 | 1.55 | 56.1 | −0.9104 |
| S2 | Aspheric | 11.2878 | 0.2141 | | | 16.4312 |
| STO | Spherical | Infinite | −0.1578 | | | |
| S3 | Aspheric | 7.2370 | 0.2480 | 1.67 | 20.4 | −5.0089 |
| S4 | Aspheric | 3.8756 | 0.4435 | | | −0.4484 |
| S5 | Aspheric | 25.4270 | 0.4078 | 1.57 | 37.3 | −99.0000 |
| S6 | Aspheric | −59.3274 | 0.2270 | | | 7.9650 |
| S7 | Aspheric | 17.0783 | 0.2904 | 1.67 | 20.4 | −2.8062 |
| S8 | Aspheric | 11.5934 | 0.6048 | | | 16.6281 |
| S9 | Aspheric | −35.6017 | 0.4978 | 1.57 | 37.3 | 0.0000 |
| S10 | Aspheric | 5.9121 | 0.1955 | | | 0.0000 |
| S11 | Aspheric | 1.9641 | 0.6255 | 1.55 | 56.1 | −1.0000 |
| S12 | Aspheric | 11.5118 | 0.8975 | | | 0.0000 |
| S13 | Aspheric | 7.0848 | 0.4431 | 1.54 | 55.7 | −0.3032 |
| S14 | Aspheric | 1.8179 | 0.4144 | | | −9.6890 |
| S15 | Spherical | Infinite | 0.2100 | 1.52 | 64.2 | |
| S16 | Spherical | Infinite | D1 | | | |
| S17 | Spherical | Infinite | | | | |

D1 is shown in Table 14,

TABLE 14

| | | |
|---|---|---|
| OT | 7000 | 1000 |
| D1 | 0.4284 | 0.4581 |

Table 15 shows high-order coefficients that may be used for various aspheric lens surfaces in Example 5, wherein each aspheric surface shape may be defined by formula (1) given in Example 5 describe above.

TABLE 15

| Surface number | A4 | A6 | A8 | A10 | A12 | A14 | A16 |
|---|---|---|---|---|---|---|---|
| S1 | 4.7734E−03 | 2.9182E−02 | −1.0931E−01 | 2.6874E−01 | −4.4327E−01 | 5.1025E−01 | −4.1952E−01 |
| S2 | −1.9772E−02 | 9.3377E−03 | 2.6502E−02 | −2.9611E−02 | −9.5819E−02 | 3.2985E−01 | −4.8860E−01 |
| S3 | −2.6458E−02 | −6.5140E−02 | 5.4371E−01 | −1.8647E+00 | 4.0524E+00 | −6.0218E+00 | 6.3195E+00 |
| S4 | −2.1601E−02 | 6.7266E−02 | −3.6968E−01 | 1.5226E+00 | −3.9635E+00 | 6.7714E+00 | −7.7982E+00 |
| S5 | −9.6136E−04 | −1.3149E−01 | 9.1000E−01 | −3.8858E+00 | 1.0930E+01 | −2.1202E+01 | 2.9156E+01 |
| S6 | −2.8359E−02 | 2.4953E−02 | −1.6928E−01 | 6.9024E−01 | −1.7533E+00 | 2.9518E+00 | −3.4328E+00 |
| S7 | −8.2522E−02 | 2.2975E−01 | −1.4277E+00 | 5.6075E+00 | −1.4837E+01 | 2.7485E+01 | −3.6489E+01 |
| S8 | −5.4699E−02 | 7.2365E−02 | −3.1563E−01 | 8.8033E−01 | −1.6426E+00 | 2.1323E+00 | −1.9731E+00 |
| S9 | −5.0561E−02 | 3.4892E−02 | 3.8966E−03 | −8.2932E−02 | 1.5603E−01 | −1.6953E−01 | 1.2305E−01 |
| S10 | −2.0644E−01 | 1.9381E−01 | −2.1556E−01 | 2.1364E−01 | −1.6860E−01 | 1.0284E−01 | −4.8035E−02 |
| S11 | −1.1886E−01 | 1.0768E−01 | −9.9126E−02 | 6.5069E−02 | −3.0149E−02 | 9.8846E−03 | −2.3144E−03 |
| S12 | 2.6008E−02 | 1.6900E−02 | −3.7773E−02 | 2.8231E−02 | −1.2910E−02 | 4.0061E−03 | −8.7677E−04 |
| S13 | −2.1436E−01 | 1.3808E−01 | −7.2105E−02 | 2.8927E−02 | −8.2961E−03 | 1.6866E−03 | −2.4594E−04 |
| S14 | −7.8191E−02 | 3.5985E−02 | −1.2181E−02 | 2.8957E−03 | −4.6449E−04 | 4.6047E−05 | −1.8683E−06 |
| Surface number | A18 | A20 | A22 | A24 | A26 | A28 | A30 |
| S1 | 2.4912E−01 | −1.0688E−01 | 3.2759E−02 | −6.9822E−03 | 9.8162E−04 | −8.1728E−05 | 3.0484E−06 |
| S2 | 4.4096E−01 | −2.6376E−01 | 1.0703E−01 | −2.9203E−02 | 5.1353E−03 | −5.2611E−04 | 2.3864E−05 |
| S3 | −4.7579E+00 | 2.5796E+00 | −9.9850E−01 | 2.6920E−01 | −4.8029E−02 | 5.0978E−03 | −2.4376E−04 |
| S4 | 6.0855E+00 | −3.1452E+00 | 9.9498E−01 | −1.4218E−01 | −1.4405E−02 | 8.3808E−03 | −9.0542E−04 |
| S5 | −2.8826E+01 | 2.0545E+01 | −1.0455E+01 | 3.7024E+00 | −8.6635E−01 | 1.2036E−01 | −7.5143E−03 |
| S6 | 2.8264E+00 | −1.6678E+00 | 7.0588E−01 | −2.1145E−01 | 4.3166E−02 | −5.4680E−03 | 3.2808E−04 |
| S7 | 3.5118E+01 | −2.4522E+01 | 1.2288E+01 | −4.3030E+00 | 9.9897E−01 | −1.3805E−01 | 8.5913E−03 |
| S8 | 1.3180E+00 | −6.3663E−01 | 2.2009E−01 | −5.3027E−02 | 8.4454E−03 | −7.9779E−04 | 3.3778E−05 |
| S9 | −6.2420E−02 | 2.2461E−02 | −5.7088E−03 | 1.0010E−03 | −1.1499E−04 | 7.7726E−06 | −2.3383E−07 |
| S10 | 1.7004E−02 | −4.4855E−03 | 8.6063E−04 | −1.1591E−04 | 1.0343E−05 | −5.4747E−07 | 1.2993E−08 |
| S11 | 3.9021E−04 | −4.7434E−05 | 4.1187E−06 | −2.4915E−07 | 9.9766E−09 | −2.3773E−10 | 2.5529E−12 |
| S12 | 1.3770E−04 | −1.5578E−05 | 1.2582E−06 | −7.0752E−08 | 2.6303E−09 | −5.8089E−11 | 5.7682E−13 |
| S13 | 2.5994E−05 | −1.9964E−06 | 1.1043E−07 | −4.2916E−09 | 1.1131E−10 | −1.7316E−12 | 1.2230E−14 |
| S14 | −1.7112E−07 | 3.4157E−08 | −2.7668E−09 | 1.3331E−10 | −3.9570E−12 | 6.7171E−14 | −5.0132E−16 |

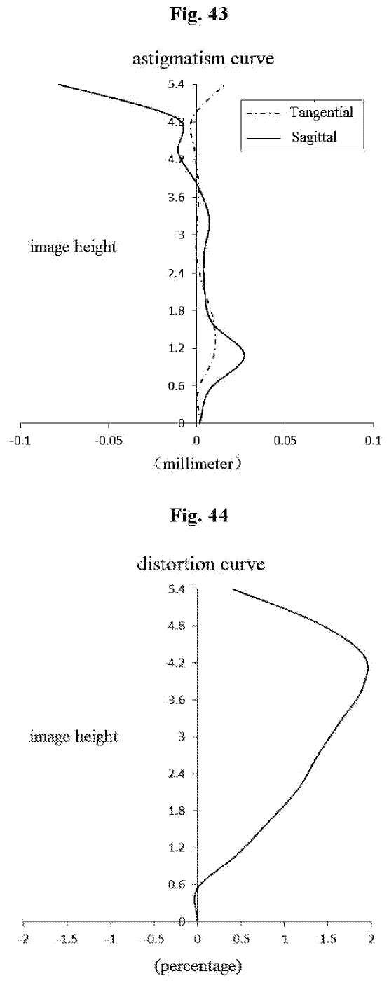

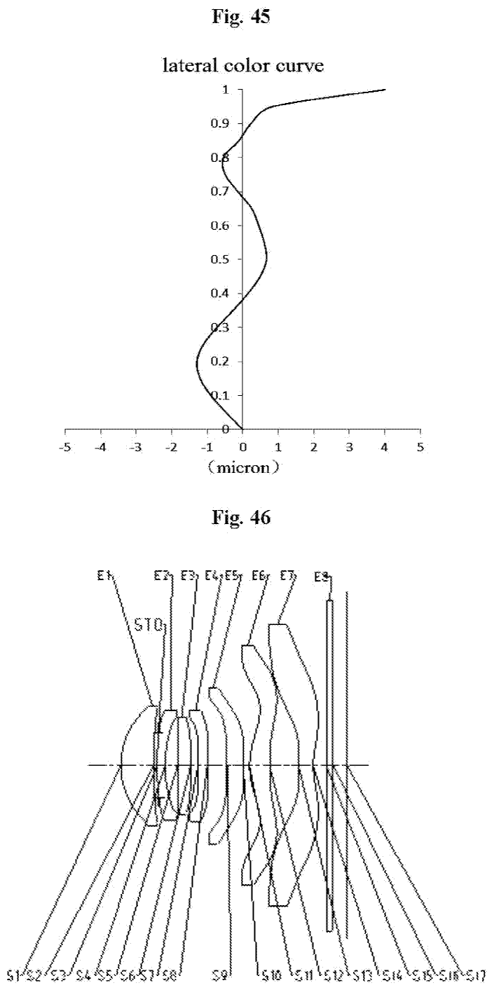

FIG. 42 shows a longitudinal aberration curve of the optical imaging lens group of Example 5 when the object distance is 7000 mm, which represents deviations of a convergence focal point after lights with different wavelengths pass through the optical imaging lens group. FIG. 43 shows an astigmatism curve of the optical imaging lens group of Example 5 when the object distance is 7000 mm, which represents a tangential image surface curvature and a sagittal image surface curvature. FIG. 44 shows a distortion curve of the optical imaging lens group of Example 5 when the object distance is 7000 mm, which represents distortion magnitude values corresponding to different field of views. FIG. 45 shows a lateral color curve of the optical imaging lens group of Example 5 when the object distance is 7000 mm, which represents deviations of different image heights on the imaging surface after the light passes through the optical imaging lens group.

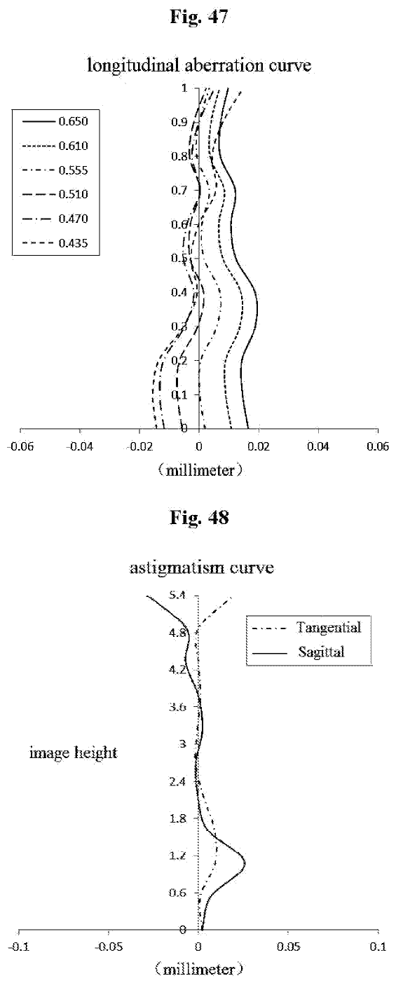

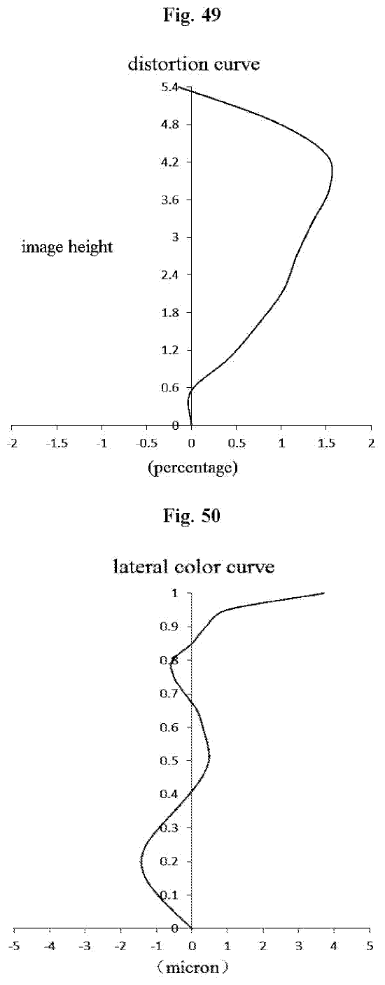

FIG. 47 shows a longitudinal aberration curve of the optical imaging lens group of Example 5 when the object distance is 1000 mm, which represents deviations of a convergence focal point after lights with different wavelengths pass through the optical imaging lens group. FIG. 48 shows an astigmatism curve of the optical imaging lens group of Example 5 when the object distance is 1000 mm, which represents a tangential image surface curvature and a sagittal image surface curvature. FIG. 49 shows a distortion curve of the optical imaging lens group of Example 5 when the object distance is 1000 mm, which represents distortion magnitude values corresponding to different field of views. FIG. 50 shows a lateral color curve of the optical imaging lens group of Example 5 when the object distance is 1000 mm, which represents deviations of different image heights on the imaging surface after the light passes through the optical imaging lens group.

It can be seen from FIGS. 42-45 and FIGS. 47-50 that, the optical imaging lens group given in Example 5 may achieve good imaging quality.

In summary, Examples 1-5 satisfy relationships shown in Table 16 respectively.

TABLE 16

| | Conditional expression\example | | | | |
|---|---|---|---|---|---|
| | 1 | 2 | 3 | 4 | 5 |
| Fno2/Fno1 | 1.54 | 1.53 | 1.53 | 1.53 | 1.53 |
| TTL/ImgH | 1.30 | 1.30 | 1.30 | 1.30 | 1.30 |
| ImgH*tan(FOV/2)(mm) | 4.90 | 4.92 | 4.91 | 4.92 | 4.97 |
| T45/CT5 | 1.26 | 1.24 | 1.23 | 1.21 | 1.21 |
| f1/f6 | 1.22 | 1.23 | 1.24 | 1.26 | 1.25 |
| T45/T56 | 3.22 | 3.19 | 3.16 | 3.07 | 3.09 |
| R14/f | 0.31 | 0.31 | 0.31 | 0.31 | 0.31 |
| R11/R14 | 1.13 | 1.10 | 1.09 | 1.08 | 1.08 |
| (CT3 + CT4)/T45 | 1.13 | 1.14 | 1.14 | 1.15 | 1.15 |
| T56/CT6 | 0.30 | 0.31 | 0.31 | 0.31 | 0.31 |
| DT21/DT32 | 1.15 | 1.15 | 1.15 | 1.15 | 1.15 |
| DT72/ImgH | 0.81 | 0.81 | 0.81 | 0.81 | 0.81 |
| (DT61 − DT52)/DT52 | 0.42 | 0.43 | 0.43 | 0.43 | 0.43 |
| SAG51/CT5 | −1.16 | −1.15 | −1.13 | −1.12 | −1.12 |
| SAG52/CT5 | −1.60 | −1.58 | −1.57 | −1.56 | −1.56 |
| SAG61/T56 | −1.33 | −1.28 | −1.25 | −1.22 | −1.23 |
| SAG72/CT7 | −1.66 | −1.71 | −1.74 | −1.83 | −1.83 |
| YC72/DT72 | 0.33 | 0.33 | 0.32 | 0.32 | 0.32 |
| ET3/CT3 | 0.64 | 0.64 | 0.64 | 0.64 | 0.64 |
| ET4/CT4 | 1.16 | 1.17 | 1.17 | 1.17 | 1.17 |
| YT62/CT6 | 0.34 | 0.35 | 0.35 | 0.36 | 0.36 |
| \|DISTmax\| | 1.91 | 1.91 | 1.92 | 1.92 | 1.91 |

Table 17 shows the effective focal length f of the optical imaging lens group, the effective focal lengths f1-f7 of various lenses, the maximum field of view (FOV), the image height ImgH and the length TTL of the optical imaging lens group of Examples 1-5.

TABLE 17

| | Parameter\example | | | | | | | | | |
|---|---|---|---|---|---|---|---|---|---|---|
| | 1 | | 2 | | 3 | | 4 | | 5 | |
| | OT = 70 | OT = 10 | OT = 70 | OT = 10 | OT = 70 | OT = 10 | OT = 70 | OT = 10 | OT = 70 | OT = 10 |
| | 00 mm | 00 mm | 00 mm | 00 mm | 00 mm | 00 mm | 00 mm | 00 mm | 00 mm | 00 mm |
| TTL (mm) | 7 | 7.03 | 7 | 7.03 | 7 | 7.03 | 7 | 7.03 | 7 | 7.03 |
| FOV (°) | 84.4 | 84.4 | 84.6 | 84.4 | 84.6 | 84.4 | 84.6 | 84.4 | 84.9 | 84.4 |
| Fno | 1.59 | 2.44 | 1.59 | 2.43 | 1.59 | 2.43 | 1.59 | 2.43 | 1.59 | 2.43 |

| | | | | | |
|---|---|---|---|---|---|
| ImgH (mm) | 5.4 | 54 | 54 | 54 | 54 |
| f (mm) | 5.89 | 5.89 | 5.89 | 5.89 | 5.89 |
| f1 (mm) | 5.32 | 5.32 | 5.32 | 5.32 | 5.32 |
| f2 (mm) | −13.02 | −12.99 | −12.95 | −12.91 | −12.91 |
| f3 (mm) | 31.53 | 31.35 | 31.31 | 31.1 | 31.31 |
| f4 (mm) | −62.67 | −58.68 | −57.83 | −54.74 | −55.39 |
| f5 (mm) | −9.14 | −8.95 | −8.88 | −8.86 | −8.87 |
| f6 (mm) | 4.38 | 4.31 | 4.28 | 4.24 | 4.24 |
| f7 (mm) | −4.76 | −4.75 | −4.73 | −4.69 | −4.69 |

The disclosure further provides an imaging device, wherein an electronic photosensitive element of which may be a photosensitive coupling element (CCD) or a complementary metal oxide semiconductor device (CMOS). The imaging device may be an independent imaging device such as a digital camera, or an imaging module integrated on a mobile electronic device such as a mobile phone. The imaging device is equipped with the optical imaging lens group described above.

Apparently, the embodiments described below are merely a part, but not all, of the embodiments of the disclosure. All of other embodiments, obtained by those of ordinary skill in the art based on the embodiments of the disclosure without any creative effort, fall into the protection scope of the disclosure.

It should be noted that, terms used herein are for the purpose of describing specific embodiments, and are not intended to limit the exemplary embodiments according to the disclosure. As used herein, unless the context clearly dictates otherwise, a singular form is intended to include a plural form as well. In addition, it should also be understood that, when the terms “comprising” and/or “including” are used in this specification, they indicate that the presence of features, steps, works, devices, components and/or combinations thereof.

It should be illustrated that, the terms “first” and “second” and the like in the specification, claims and the above-mentioned drawings of the disclosure are used for distinguishing similar objects, and are not necessarily used for describing a specific sequence or precedence order. It should be understood that the data used in this way may be interchanged under appropriate circumstances, so that the embodiments of the disclosure described herein may be implemented in a sequence other than those illustrated or described herein.

The foregoing descriptions are only specific embodiments of the disclosure, and are not intended to limit the disclosure, and for those skilled in the art, the disclosure may have various modifications and changes. Any modifications, equivalent replacements, improvements and the like, made within the spirit and principle of the disclosure, shall all be included in the protection scope of the disclosure.

What is claimed is:

1. An optical imaging lens group, sequentially comprising from an object side to an image side along an optical axis:
a first lens with a positive refractive power, and an image-side surface of the first lens is a concave surface;
a second lens with a refractive power, and an image-side surface of the second lens is a concave surface;
a third lens with a refractive power;
a fourth lens;
a fifth lens with a refractive power, and an object-side surface of the fifth lens is a concave surface;
a sixth lens with a positive refractive power, and an object-side surface of the sixth lens is a convex surface;
a seventh lens with a negative refractive power, and an image-side surface of the seventh lens is a concave surface; and
an iris diaphragm, the iris diaphragm is arranged between the first lens and the second lens;
wherein Fno2 is an F-number when an object distance of the optical imaging lens group is 1000 mm, Fno1 is an F-number when the object distance of the optical imaging lens group is 7000 mm, and Fno2 and Fno1 satisfy: 1.3<Fno2/Fno1<1.8; and
ImgH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5.

2. The optical imaging lens group according to claim 1, wherein an effective focal length f1 of the first lens and an effective focal length f6 of the sixth lens satisfy: 1<f1/f6<1.5.

3. The optical imaging lens group according to claim 1, wherein T45 is an on-axis spacing distance between the fourth lens and the fifth lens, T56 is an on-axis spacing distance between the fifth lens and the sixth lens, and T45 and T56 satisfy: 3<T45/T56<3.5.

4. The optical imaging lens group according to claim 1, wherein a curvature radius R14 of the image-side surface of the seventh lens and an effective focal length f of the optical imaging lens group satisfy: R14/f<0.5.

5. The optical imaging lens group according to claim 1, wherein a curvature radius R11 of the object-side surface of the sixth lens and a curvature radius R14 of the image-side surface of the seventh lens satisfy: 0.9<R11/R14<1.3.

6. The optical imaging lens group according to claim 1, wherein T45 is an on-axis spacing distance T45 between the fourth lens and the fifth lens, a center thickness CT3 of the third lens on the optical axis, a center thickness CT4 of the fourth lens on the optical axis and T45 satisfy: 1<(CT3+CT4)/T45<1.5.

7. The optical imaging lens group according to claim 1, wherein T56 is an on-axis spacing distance between the fifth lens and the sixth lens and a center thickness CT6 of the sixth lens on the optical axis satisfy: 0.2<T56/CT6<0.7.

8. The optical imaging lens group according to claim 1, wherein a maximum effective radius DT21 of an object-side surface of the second lens and a maximum effective radius DT32 of an image-side surface of the third lens satisfy: 1<DT21/DT32<1.5.

9. The optical imaging lens group according to claim 1, wherein a maximum effective radius DT72 of the image-side surface of the seventh lens and ImgH satisfy: 0.5<DT72/ImgH<1.

10. The optical imaging lens group according to claim 1, wherein a maximum effective radius DT61 of the object-side surface of the sixth lens and a maximum effective radius DT52 of an image-side surface of the fifth lens satisfy: 0.2<(DT61−DT52)/DT52<0.6.

11. The optical imaging lens group according to claim 1, wherein SAG51 is an on-axis spacing distance from an intersection point of the object-side surface of the fifth lens and the optical axis to an effective radius vertex of the object-side surface of the fifth lens, SAG51 and a center thickness CT5 of the fifth lens on the optical axis satisfy: −1.5<SAG51/CT5<−1.

12. The optical imaging lens group according to claim 1, wherein SAG52 is an on-axis spacing distance from an intersection point of an image-side surface of the fifth lens and the optical axis to an effective radius vertex of the image-side surface of the fifth lens, SAG52 and a center thickness CT5 of the fifth lens on the optical axis satisfy: −1.8<SAG52/CT5<−1.3.

13. The optical imaging lens group according to claim 1, wherein SAG61 is an on-axis spacing distance from an intersection point of the object-side surface of the sixth lens and the optical axis to an effective radius vertex of the object-side surface of the sixth lens, T56 is an on-axis spacing distance between the fifth lens and the sixth lens, and SAG61 and T56 satisfy: −1.5<SAG61/T56<−1.

14. The optical imaging lens group according to claim 1, wherein SAG72 is an on-axis spacing distance from an intersection point of the image-side surface of the seventh lens and the optical axis to an effective radius vertex of the image-side surface of the seventh lens, SAG72 and a center thickness CT7 of the seventh lens on the optical axis satisfy: −2<SAG72/CT7<−1.

15. The optical imaging lens group according to claim 1, wherein YC72 is a vertical distance from a critical point of the image-side surface of the seventh lens to the optical axis, YC72 and a maximum effective radius DT72 of the image-side surface of the seventh lens satisfy: 0.1<YC72/DT72<0.5.

16. The optical imaging lens group according to claim 1, wherein an edge thickness ET3 of the third lens at a maximum effective diameter and a center thickness CT3 of the third lens on the optical axis satisfy: 0.5<ET3/CT3<1.

17. The optical imaging lens group according to claim 1, wherein an edge thickness ET4 of the fourth lens at the maximum effective diameter and a center thickness CT4 of the fourth lens on the optical axis satisfy: 0.9<ET4/CT4<1.3.

18. The optical imaging lens group according to claim 1, wherein YT62 is an on-axis spacing distance from an intersection point of an image-side surface of the sixth lens and the optical axis to a critical point of the image-side surface of the sixth lens, YT62 and a center thickness CT6 of the sixth lens satisfy: 0<YT62/CT6<0.6.

19. The optical imaging lens group according to claim 1, wherein DISTmax is a maximum optical distortion of the optical imaging lens group, when an F-number of the optical imaging lens group is maximum or minimum, DISTmax satisfies: |DISTmax|<5%.

20. An optical imaging lens group, sequentially comprising from an object side to an image side along an optical axis:
a first lens with a positive refractive power, and an image-side surface of the first lens is a concave surface;
a second lens with a refractive power, and an image-side surface of the second lens is a concave surface;
a third lens with a refractive power;
a fourth lens;
a fifth lens with a refractive power, and an object-side surface of the fifth lens is a concave surface;
a sixth lens with a positive refractive power, and an object-side surface of the sixth lens is a convex surface;
a seventh lens with a negative refractive power, and an image-side surface of the seventh lens is a concave surface; and
an iris diaphragm, the iris diaphragm is arranged between the first lens and the second lens;
wherein IrrigH is a half of a diagonal length of an effective pixel region on an imaging surface of the optical imaging lens group, FOV is a maximum field of view of the optical imaging lens group, and ImgH and FOV satisfy: 4.5<ImgH*tan(FOV/2)<5.5; and
T45 is an on-axis spacing distance between the fourth lens and the fifth lens, and T45 and a center thickness CT5 of the fifth lens on the optical axis satisfy: 1<T45/CT5<1.5.
